(19) United States
(12) Patent Application Publication
(10) Pub. No.: US 2023/0419806 A1
(43) Pub. Date: Dec. 28, 2023

(54) METHOD AND SYSTEM FOR DEVICE MONITORING AND DIAGNOSTICS

(71) Applicant: Serverli, Inc., Winter Garden, FL (US)

(72) Inventors: Elijah L. ROSENBERG, Winter Garden, FL (US); Frank DIMARTINO, Mont Vernon, NH (US)

(73) Assignee: Serverli, Inc., Winter Garden, FL (US)

(21) Appl. No.: 18/340,441

(22) Filed: Jun. 23, 2023

Related U.S. Application Data
(60) Provisional application No. 63/355,784, filed on Jun. 27, 2022.

(51) Int. Cl. G08B 19/00; H04L 67/303; H04L 67/141; H04L 9/40

(52) U.S. Cl. CPC G08B 19/00; H04L 67/303; H04L 67/141; H04L 63/08

(57) ABSTRACT

A method, system, and computer program product are disclosed for monitoring devices which may include a processor for storing device profiles for a plurality of devices, each device profile including a device type and a device manufacturer. The processor may receive a user selection of a device profile, an internet protocol (IP) address for a target device, and user login credentials for a user account used with an application programming interface (API) associated with the manufacturer of the target device. The processor may establish an active connection through the API and receive device parameter selections from the user. The processor may receive target device data via the API, determine that the device data indicates operation of the target device outside of the device parameter selections, generate an alert indicating the target device is operating outside of the device parameter selections, and transmit the alert to a user device.

### CROSS-REFERENCE

This Non-Provisional application is related to and claims priority to U.S. Provisional Application No. 63/355,784, filed on Jun. 27, 2022, the entire contents of which are incorporated herein by reference.

### FIELD

The present disclosure relates to methods and systems for monitoring one or more devices. In particular embodiments, the present disclosure is particularly applicable to monitoring of devices for network and premises security purposes.

### BACKGROUND

Myriad electronic devices provide data that may be monitored. However, existing systems that attempt to monitor the wide variety of devices available are cumbersome for non-technical end users given the numerous different communication implementations for individual devices. Given the numerous different communication implementations for individual devices, there is an ever present need to continually create customized and highly technical communication connections with such devices. Thus, there is a need for a novel solution for a monitoring system that is specifically designed for non-technical end users which significantly eases configuration of monitoring and administration of monitoring of a wide variety of devices that provide data that may be monitored.

### SUMMARY

Embodiments of the present disclosure provide a network monitoring and alerts tool designed specifically for the non-technical end-user. With the monitoring, reports, device templates, and data security according to embodiments of the present disclosure, an end-user will have a glimpse at what network devices are doing securely with very little or no technical training. Embodiments of the present disclosure take device monitoring into the next generation with a sleek modem, user-friendly UI and provide users with the feeling like a network engineer with some of the latest technologies.

Embodiments of the present disclosure allow an end-user to easily protect their most vital security and event information collected from almost any computing or Internet of Things (IoT) device with an internet connection. Critical information and events from servers, network devices, cameras, door access controls, kiosks, network video recorders (NVRs), and much more may be equally secured in a protected manner from system failures, drive failures, and any other events that may compromise or disable mission-critical equipment by embodiments of the present disclosure. Embodiments of the present disclosure use application programming interfaces (APIs), which one of ordinary skill in the art appreciates as generally referring to a software intermediary that allows two items of hardware or software in any combination to communicate with one another using a known scheme or schema.

A method is disclosed of monitoring one or more devices, the method including storing a plurality of device profiles for a plurality of devices, each device profile of the plurality of device profiles including at least a device type and a device manufacturer; receiving a user selection of a device profile of the plurality of device profiles and an internet protocol (IP) address for a target device corresponding to the selected device profile; receiving user login credentials associated with the target device, the user login credentials being credentials for a user account used with an API associated with the manufacturer of the target device; establishing an active connection through the API to the target device and/or to a software platform associated with the target device; receiving one or more device parameter selections from the user, the one or more device parameter selections defining device monitoring parameters; receiving target device data via the API; determining that the device data indicates operation of the target device outside of the one or more device parameter selections; generating an alert indicating the target device is operating outside of the one or more device parameter selections; and transmitting the alert to a user device.

In some embodiments, receiving an IP address for a device corresponding to the selected device profile may include: receiving, by the processing server, a network identification from the user; and detecting, by the processing server, a user device corresponding to the selected device profile on the network.

In some embodiments, the plurality of devices may include one or more from the group consisting of: a server, a desktop computing device, a laptop computing device, a mobile device, a hypervisor, a camera, a security sensor, a pressure sensor, a glass break sensor, a motion sensor, a temperature control device, a temperature sensor, and an Internet-of-Things (IOT) sensor.

In some embodiments, the user login credentials may be in the format of one of the following: Simple Network Management Protocol (SNMP) v1, SNMPv2, Hypertext Transfer Protocol (HTTP), SNMPv3, Secure Shell Protocol (SSH), Windows Management Instrumentation (WMI), Windows, Linux.

In some embodiments, the one or more device parameter selections may include one or more of: a computer processing unit (CPU) utilization parameter, a random access memory (RAM) utilization parameter, a hard drive parameter, a network parameter, a bandwidth parameter, a temperature parameter, a device status parameter, and a database parameter.

In some embodiments, the alert may include one or more of: a CPU utilization alert, a RAM utilization alert, a failed create/read/update/delete (CRUD) alert, a failed drive alert, a drive space alert, a dropped packet(s) alert, a device temperature alert, an environmental temperature alert, a device offline/online alert, a motion detection alert, and a pressure change alert.

In some embodiments, the alert may include one or more of: an email, a short message service (SMS) alert, and a pop-up notification.

In some embodiments, the method may include generating, by the processing server, a summary report of one or more alerts for the one or more target devices, wherein the summary report summarizes alerts during a defined period of time.

In some embodiments, the method may include receiving, by the processing server, a device parameter selection update from the user.

In some embodiments, the method may include changing a configuration of the target device in response to the determination that the device data indicates operation of the target device outside of the one or more device parameter selections.

In some embodiments, the configuration of the target device is the closing of an IP port or the shutting down of a service or software function.

A system is disclosed for monitoring one or more devices. The system includes a processing device configured to store a plurality of device profiles for a plurality of devices, each device profile of the plurality of device profiles including at least a device type and a device manufacturer; receive a user selection of a device profile of the plurality of device profiles and an IP address for a target device corresponding to the selected device profile; receive user login credentials associated with the target device, the user login credentials being credentials for a user account used with an API associated with the manufacturer of the target device; establish an active connection through the API to the target device and/or to a software platform associated with the target device; receive one or more device parameter selections from the user, the one or more device parameter selections defining device monitoring parameters; receive target device data via the API; determine that the device data indicates operation of the target device outside of the one or more device parameter selections; generate an alert indicating the target device is operating outside of the one or more device parameter selections; and transmit the alert to a user device.

In some embodiments, when receiving an IP address for a device corresponding to the selected device profile, the processing device may be configured to receive a network identification from the user; and detect a user device corresponding to the selected device profile on the network.

In some embodiments, the plurality of devices may include one or more from the group consisting of: a server, a desktop computing device, a laptop computing device, a mobile device, a hypervisor, a camera, a security sensor, a pressure sensor, a glass break sensor, a motion sensor, a temperature control device, a temperature sensor, and an Internet-of-Things (IOT) sensor.

In some embodiments, the user login information may be in the format of one of the following: Simple Network Management Protocol (SNMP) v1, SNMPv2, Hypertext Transfer Protocol (HTTP), SNMPv3, Secure Shell Protocol (SSH), Windows Management Instrumentation (WMI), Windows, Linux.

In some embodiments, the one or more parameter selections may include one or more of: a computer processing unit (CPU) utilization parameter, a random access memory (RAM) utilization parameter, a hard drive parameter, a network parameter, a bandwidth parameter, a temperature parameter, a device status parameter, and a database parameter.

In some embodiments, the alert may include one or more of: a CPU utilization alert, a RAM utilization alert, a failed create/read/update/delete (CRUD) alert, a failed drive alert, a drive space alert, a dropped packet(s) alert, a device temperature alert, an environmental temperature alert, a device offline/online alert, a motion detection alert, and a pressure change alert.

In some embodiments, the alert may include one or more of: an email, a short message service (SMS) alert, and a pop-up notification.

In some embodiments, the processing device may be configured to generate a summary report of one or more alerts for the one or more target devices, wherein the summary report summarizes alerts during a defined period of time.

In some embodiments, the processing device may be configured to receive a device parameter selection update from the user.

In some embodiments, the processing device may be configured to change a configuration of the target device in response to the determination that the device data indicates operation of the target device outside of the one or more device parameter selections.

In some embodiments, the configuration of the target device is the closing of an IP port or the shutting down of a service or software function.

A computer program product is disclosed of monitoring one or more devices, the computer program product including a computer-readable storage medium having program instructions embodied therewith, the program instructions executable by a computer to cause the computer to perform a method, including: storing, by a processing server, a plurality of device profiles for a plurality of devices, each device profile of the plurality of device profiles including at least a device type and a device manufacturer; receiving, by the processing server, a user selection of a device profile of the plurality of device profiles and an IP address for a target device corresponding to the selected device profile; receiving, by the processing server, user login credentials associated with the target device, the user login credentials being credentials for a user account used with an application programming interface (API) associated with the manufacturer of the target device; establishing, by the processing server, an active connection through the API to the target device and/or to a software platform associated with the target device; receiving, by the processing server, one or more device parameter selections from the user, the one or more device parameter selections defining device monitoring parameters; receiving, by the processing server, target device data via the API; determining, by the processing server, that the device data indicates operation of the target device outside of the one or more device parameter selections; generating, by the processing server, an alert indicating the target device is operating outside of the one or more device parameter selections; and transmitting, by the processing server, the alert to a user device.

In some embodiments, the alert may include one or more of: an email, a short message service (SMS) alert, and a pop-up notification.

In some embodiments, the computer program product may include program instructions to generate a summary report of one or more alerts for the one or more target devices, wherein the summary report summarizes alerts during a defined period of time.

In some embodiments, the computer program product may include program instructions to receive a device parameter selection update from the user.

In some embodiments, the computer program product may include program instructions to change a configuration of the target device in response to the determination that the device data indicates operation of the target device outside of the one or more device parameter selections.

In some embodiments, the configuration of the target device may include the closing of a IP port or the shutting down of a service or software function.

### BRIEF DESCRIPTION OF THE DRAWING FIGURES

The scope of the present disclosure is best understood from the following detailed description of example embodiments when read in conjunction with the accompanying drawings. Included in the drawings are the following figures:

FIGS. 1-5 are block diagrams illustrating system architectures for monitoring one or more devices in accordance with example embodiments;

FIGS. 6-7 are flowcharts illustrating methods for monitoring one or more devices in accordance with example embodiments;

FIG. 8 illustrates data structures used in example embodiments of the present disclosure;

FIGS. 9-13 are diagrams illustrating user interfaces of the device monitoring program of FIG. 1 in accordance with example embodiments;

FIG. 14 is a block diagram illustrating a computer system architecture in accordance with example embodiments;

FIG. 15 is a block diagram illustrating a container architecture in accordance with example embodiments;

FIG. 16 is a flowchart illustrating methods for autodiscovery of devices in accordance with example embodiments;

FIG. 17 is a schematic diagram of an exemplary implementation of a device monitoring program in a private on-premise network in accordance with example embodiments;

FIG. 18 is a schematic diagram of an exemplary implementation of the device monitoring program 120 in a private on-premise multi-network in accordance with example embodiments;

FIG. 19 is a schematic diagram of an exemplary implementation of the device monitoring program 120 in a hybrid-cloud network in accordance with example embodiments;

FIG. 20 is a schematic diagram of an exemplary architecture for an application engine for a device monitoring program in accordance with example embodiments;

FIG. 21 is a schematic diagram of an exemplary implementation of a device monitoring program in the form of a web application in accordance with example embodiments; and

FIG. 22 is a schematic diagram of an exemplary implementation of a device monitoring program in the form of a web application having multiple tools in accordance with example embodiments.

### DETAILED DESCRIPTION

### System Overview

Embodiments of the disclosed methods, systems, and computer program products may provide for efficient monitoring of devices on a network while also providing for enhanced computer security and network security. Embodiments of the disclosed subject matter may improve network security by providing monitoring and detection of status, activity, parameters, and other features of network devices. Detection may include detection of anomalies or other security and/or safety vulnerabilities that may defined and detected in a network of computing devices. Embodiments of the disclosed subject matter may also provide for automatic alerting and automatic remediation of detected anomalies by performing an action on a device in the network to increase security, disable a security breach in a device on the network, or disable a device on the network to prevent a malfunction or safety issue.

Such embodiments of the disclosed subject matter are configured such that they provide ease of use to users with little to no configuration required by the user and do not require the user to have any special knowledge of networking or information technology techniques. Thus, security can be easily enhanced and improved by using embodiments in a network of devices and a network of devices can use embodiments of the disclosed subject matter without the need for reconfiguration of the network or the devices on the network. Embodiments of the disclosed subject matter thus can enhance network security and provide an application of device monitoring to enhance the operation of a network of computing devices.

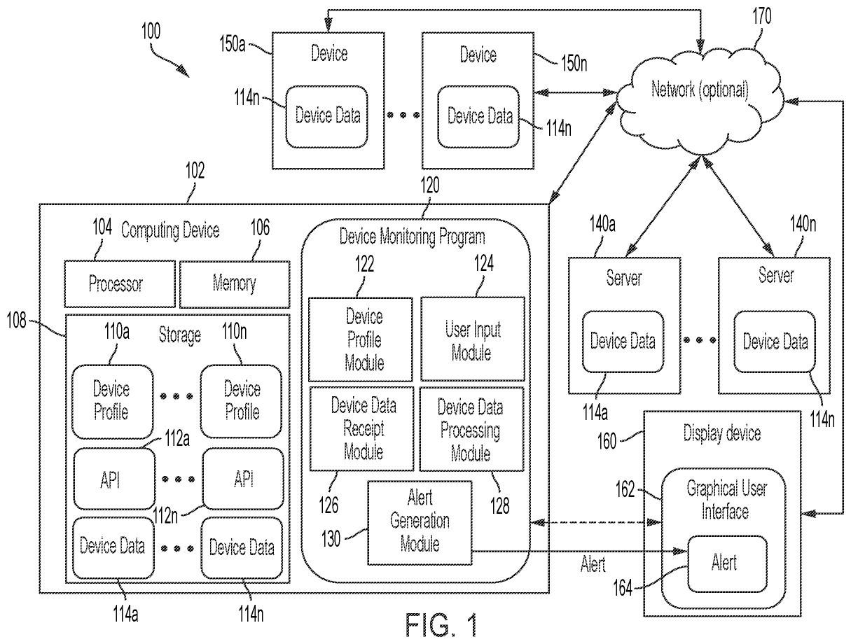

FIG. 1 illustrates system 100 for monitoring one or more devices in accordance with example embodiments.

The computing device 102 includes, for example, a processor 104, a memory 106, a storage 108, and a device monitoring program 120. The computing device 102 may be a desktop computer, a notebook, a laptop computer, a tablet computer, a handheld device, a smart-phone, a thin client, or any other electronic device or computing system capable of storing, compiling, and organizing audio, visual, or textual data and receiving and sending that data to and from other computing devices, such as the servers 140a-140n, the devices 150a-150n, and the display device 160.

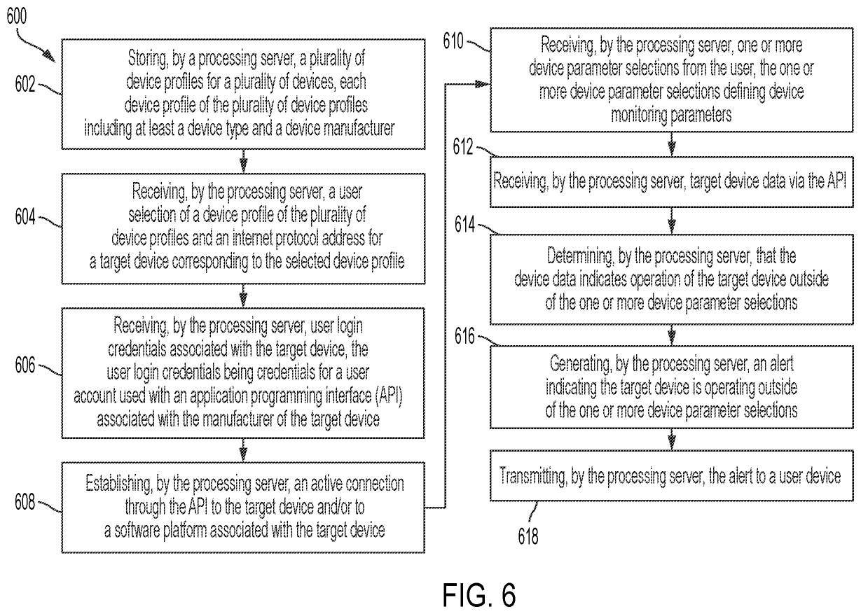

The processor 104 may be a special purpose or a general purpose processor device specifically configured to perform the functions discussed herein. The processor 104 unit or device as discussed herein may be a single processor, a plurality of processors, or combinations thereof. Processor devices may have one or more processor “cores.” In an example embodiment, the processor 104 is configured to perform the functions associated with the modules 122-130 of the device monitoring program 120 as discussed below with reference to FIGS. 6-13.

The memory 106 may be a random access memory, read-only memory, or any other known memory configurations. Further, the memory 106 may include one or more additional memories including the storage 108 in some embodiments. The memory 106 and the one or more additional memories may be read from and/or written to in a well-known manner. In an embodiment, the memory and the one or more additional memories may be non-transitory computer readable recording media. Memory semiconductors (e.g., DRAMs, etc.) may be means for providing software to the computing device 102 such as the device monitoring program 120. Computer programs, e.g., computer control logic, may be stored in the memory 106.

The storage 108 may include, for example, devices profiles 110a-110n, APIs 112a-112n, and device data 114a-114n. The storage 108 may be deployed on one or more nodes, e.g., storage or memory nodes, or one or more processing-capable nodes such as a server computer, desktop computer, notebook computer, laptop computer, tablet computer, handheld device, smart-phone, thin client, or any other electronic device or computing system capable of storing, compiling, and/or processing data and computer instructions (e.g., devices profiles 110a-110n, APIs 112a-112n, and device data 114a-114n), and receiving and sending that data to and from other devices, such as the computing device 102, servers 140a-140n, and the display device 160. The storage 108 may be any suitable storage configuration, such as, but not limited to, a relational database, a structured query language (SQL) database, a distributed database, or an object database, etc. Suitable configurations and storage types will be apparent to persons having skill in the relevant art.

The device profiles 110a-110n include at least a device type and a device manufacturer. In embodiments, use of such device profiles allow for a correlation to an application programming interface (API) that may be used to communicate directly with the device or a software platform associated with the device, as discussed below.

The application programming interfaces (APIs) 112a-112n are associated with the manufacturer of a target device (e.g. devices 150a-150n) and allow for communication through an active connection with the target device or through an active connection with a software platform associated with the target device. Such a software platform may be cloud-based.

One of skill in the art appreciates that cloud-based services are implemented in a variety of different ways and generally refers to the rendering of a service through the internet including data storage, servers, databases, networking, and software. Such cloud-based services provide services on-demand through a known interface without hindering the end user or end user software with the details of the cloud-based system's implementation details. For example, in one such embodiment incorporating a cloud-based service, the software platform associated with the target device discussed above resides and/or executes on a central server (140a) or collection of servers (140a-140n), each server and software platform addressable using a universal resource locator (URL) over the internet or any other network (e.g. network 170).

In such an embodiment, the device monitoring program 120, discussed in more detail below, is agnostic concerning the details of the software platform's implementation, and interacts with the cloud-based service solely through the internet without being burdened with the details of the cloud-based service's implementation details. Due to the ability of the device monitoring platform to remain agnostic concerning the software platform and/or cloud-based services and any implementation details, the device monitoring program 120 can be scaled to operate with many different devices 150 and different networks 170 such that deployment of the device monitoring program and new devices 150 is efficient and easy to accommodate for a user.

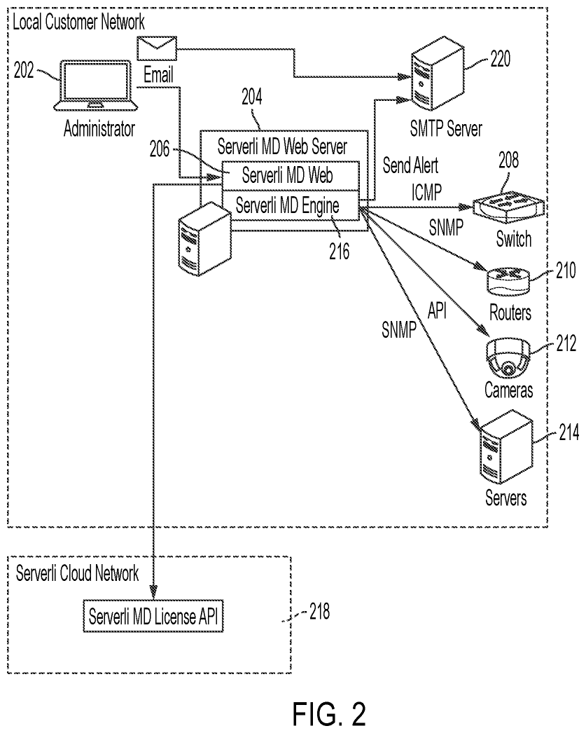

In an example embodiment, the cloud-based service may be associated with the cameras 212 illustrated in FIG. 2. The cameras 212 associated with the cloud-based service may be queried (e.g., based on selected parameters) by embodiments of the present invention for monitoring parameters as discussed more fully below.

The device data 114a-114n may be any data associated with respective devices 150a-150n. In some embodiments, the device data 114a-114n may be device monitoring parameters. Device data 114 and device monitoring parameters may be stored in storage 108 in a form of arrays. Device data 114 and/or device monitoring parameters may then be at least a single-element array, or may have multiple elements depending on the data and/or device parameter. For example, a device that has multiple central processing units (CPU) with a device monitoring parameter set as CPU temperature may have associated device data in the form of an array, such as: CPUs=[[Speed: 3 GHz, Socket: 1, Temperature: 70 C, Fan Speed: 80%], [Speed: 3 GHz, Socket: 2, Temperature: 70 C, Fan Speed: 80%], [Speed: 3 GHz, Socket: 3, Temperature: 110 C, Fan Speed: 50%]]. In this way, the device monitoring program 120 can handle mapping data elements to specific devices without requiring any special configuration.

The device monitoring program 120 is a software component and/or software instructions (e.g., a software application, a program, an executable, and/or the like) for monitoring one or more devices as further explained in FIGS. 2-13 and their associated disclosure. In an example embodiment, the device monitoring program 120 includes a device profile module 122 to interact with device profiles 110a-110n, a user input module 124 for receiving user input, a device data receipt module 126 to receive data associated with devices 150a-150n, a device data processing module 128 to process data associated with devices 150a-150n, and an alert generation module 130 to generate alerts associated with data associated with devices 150a-150n.

The device monitoring program 120 is a software component and/or software instructions specifically configured to implement the methods and functions disclosed herein for each of the device profile module 122, user input module 124, data receipt module 126, the device data processing module 128, and the alert generation module 130 when the device monitoring program 120 is executed by at least one processor 104. The device monitoring program 120 and the device profile module 122, user input module 124, data receipt module 126, the device data processing module 128, and the alert generation module 130 are further explained in FIGS. 2-13 and their associated textual disclosure.

The device monitoring program 120 may include a graphical user interface 162. The graphical user interface 162 may include components used to receive input from the computing device 102 (e.g., a user operating the computing device 102). The graphical user interface 162 of the device monitoring program 120 may render on the computing device 102 and/or a display device 160 thereof. The graphical user interface 162 may transmit the input to the device monitoring program 120 or conversely may receive information from the device monitoring program 120 and display the information on the computing device 102, and/or the display device 160.

In an example embodiment, the graphical user interface 162 uses a combination of technologies and devices, such as device drivers, to provide a platform to enable users of the computing device 102, and/or the display device 160 to interact with the device monitoring program 120. In the example embodiment, the graphical user interface 162 receives input from a physical input device, such as a keyboard, mouse, touchpad, touchscreen, camera, microphone, etc. (e.g., a user using the physical device). In an example embodiment, the graphical user interface 162 may display an alert 164 generated by the alert generation module 130. While the graphical user interface 162 is illustrated as part of the display device 160, it will be appreciated that the graphical user interface 162 is a part of the device monitoring program 120 and may be a part of the computing device 102, and/or the display device 160.

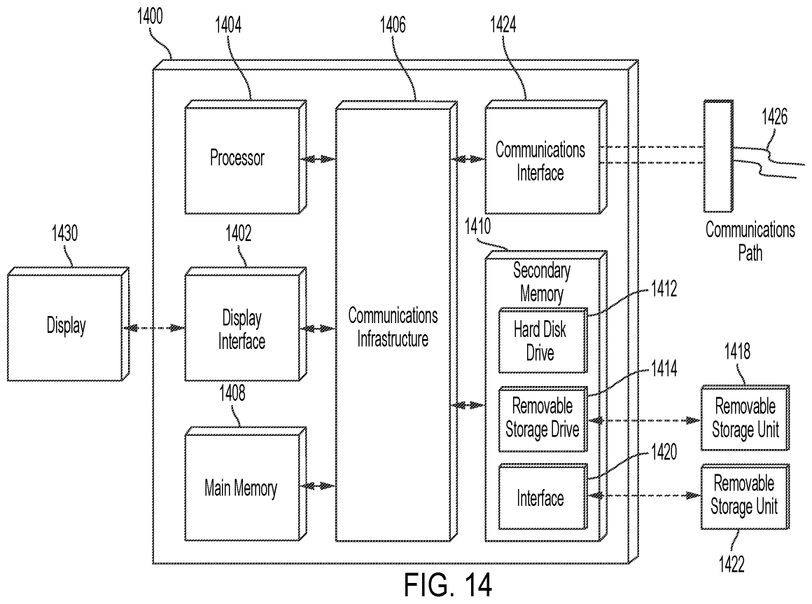

While the processor 104, the memory 106, the storage 108, and the device monitoring program 120 are illustrated as part of the computing device 102, it will be appreciated that each of these elements or a combination thereof may be a part of a separate computing device (e.g., distributed computing devices). It will be apparent to persons having skill in the relevant art that the embodiment of the computing device 102 illustrated in FIG. 1 is provided as illustration only and may not be exhaustive to all possible configurations of the computing device 102 suitable for performing the functions as discussed herein. For example, the computer system 1400 illustrated in FIG. 14 and discussed in more detail below may be a suitable configuration of the computing device 102.

The display device 160 may include the graphical user interface 162. For example, the display device 160 may display the graphical user interface 162. The display device 160 may be any computing device, and/or may be included in another computing device such as, but not limited to, a cell phone, a server computer, a desktop computer, a notebook, a laptop computer, a tablet computer, a handheld device, a smart-phone, a thin client, or any other electronic device or computing system capable of receiving display signals from another computing device, such as the computing device 102, etc. and outputting those display signals to a display device such as, but not limited to, an LCD screen, plasma screen, LED screen, DLP screen, CRT screen, etc.

For example, the graphical user interface 162 may receive an alert 164 generated by the alert generation module 130 of the device monitoring program 120 and may display the alert 164 on the display device 160. The graphical user interface 162 may receive user login credentials associated with a target device (e.g., one of devices 150a-150n) via one or more input devices (e.g., a keyboard), the user login credentials being credentials for a user account used with an application programming interface (API) associated with the manufacturer of the target device. The display device 160 may communicate with the computing device 102 via a hard-wired connection or via the network 170. For example, the display device 160 may have a hard-wired connection such as, but not limited to, a USB connection, an HDMI connection, a display port connection, a VGA connection, or any other known hard-wired connection capable of transmitting and/or receiving data between the computing device 102 and the display device 160.

While the display device 160 is illustrated as being separate from the computing device 102, it will be appreciated that the display device 160 may be a part of the computing device 102. It will be apparent to persons having skill in the relevant art that the embodiment of the display device 160 illustrated in FIG. 1 is provided as illustration only and may not be exhaustive to all possible configurations of the display device 160 suitable for performing the functions as discussed herein. For example, the computer system 1400 illustrated in FIG. 14 and discussed in more detail below may be a suitable configuration of the display device 160.

The optional network 170 may be any network suitable for performing the functions as disclosed herein and may include a local area network (LAN), a wide area network (WAN), a wireless network (e.g., Wi-Fi), a personal area network (PAN) (e.g., Bluetooth), a near-field communication (NFC) network, a mobile communication network, a satellite network, the Internet, fiber optic, coaxial cable, other hardwired networks, infrared, radio frequency (RF), or any combination of the foregoing. Other suitable network types and configurations will be apparent to persons having skill in the relevant art. In general, the network 170 may be any combination of connections and protocols that will support communications between the computing device 102, the display device 160, the devices 150a-150n, and servers 140a-140n. In some embodiments, the network 170 may be optional based on the configuration of the computing device 102, the display device 160, the devices 150a-150n, and servers 140a-140n.

### Example Method of Monitoring One or More Devices

FIG. 2 illustrates aspects of a system architecture of the present disclosure in an exemplary embodiment. As shown in FIG. 2, an administrator 202 (e.g., a computing device configured as an administrator 202) may administer a device monitoring program 120 in the form of a web server 204 (e.g., a web server executing device monitoring program 120) with a web server interface 206. The web server 204 includes a monitoring engine 216 that communicates to various devices (208-214) to be monitored. For example, devices that may be monitored include a network switch 208, network routers 210, cameras 212, and servers 214. Communications may be accomplished in various ways as illustrated in FIG. 2 including through Internet Control Message Protocol (ICMP), Simple Network Management Protocol (SNMP), or through specific APIs. Alerts may be generated based on device monitoring parameters associated with and/or assigned to the various devices shown in FIG. 2. For example, alerts may be emailed through a SMTP email server 220 to an end user, such as a user of display device 160 illustrated in FIG. 1. The present disclosure also includes the capability of confirming licensing information through a licensing API using a cloud network 218.

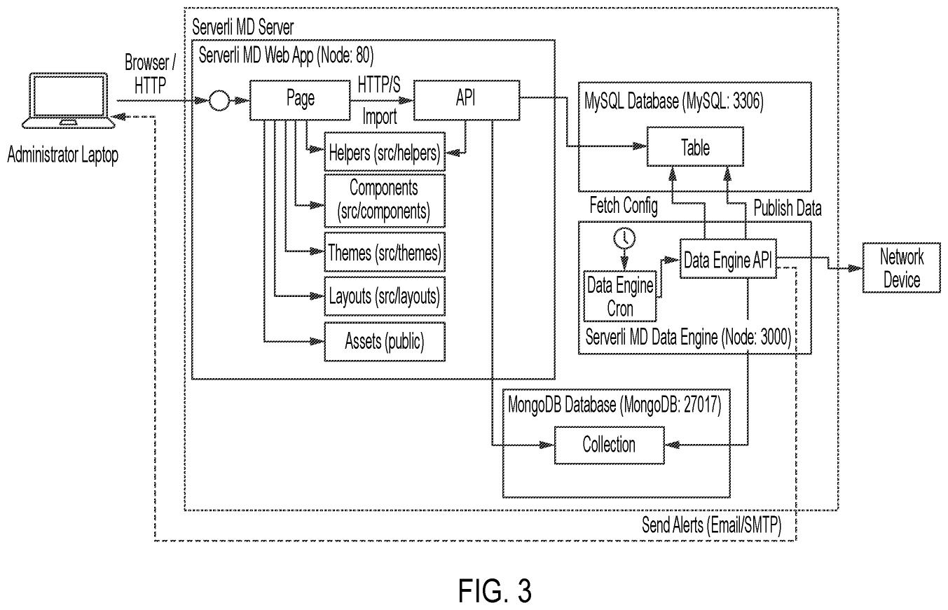

FIG. 3 illustrates further exemplary system architecture of the present disclosure in some embodiments, and includes details concerning sub-modules. FIG. 3 includes architecture concerning collection and storage of device data (e.g., device monitoring parameters) associated with target devices, such as devices 150a-150n as illustrated in FIG. 1. In the example illustrated in FIG. 3, an end user (e.g., a user of computing device 102) connects to the Web User Interface which may access an API (e.g., the Data Engine API). A cron (e.g., Data Engine Cron) may be used to schedule execution of a monitoring engine 216 (e.g., Data Engine). In some embodiments, the monitoring engine 216 may include both a cron to execute the data engine as well as a data engine API. The API direct connects to the MySql database to verify the software license. The license database contains the base license which includes customer information and a number of devices allowed. The monitoring engine 216 probes each configured device and reports the status to a database (e.g., a MongoDB® Database). For example, the monitoring engine 216 may probe a single device, a plurality of devices, or all devices in a network. The monitoring engine 216 may probe the devices in the network to determine a status of each device (e.g., successfully probed, failed to probe) and other data associated with the device. The data associated with each device and the status of each device may be stored in a database. The end user is then able to view the data collection within the Web Interface UI, for example, on a display device 160. System alerts may be sent through email (SMTP).

In some embodiments, processor 104 may execute a separate cron application such that the cron application is separate from the monitoring engine 216. In this way, the cron application may execute as a separate component form the monitoring engine 216 (e.g., the cron application is not dependent on the monitoring engine 216) and multiple schedules tasks and/or jobs may be added to the cron application. For example, the cron application may run standalone and separate from other applications of the device monitoring program 120 such that different applications that are unrelated to each other and perform completely separate functions (e.g., monitoring engine 216 and retention policy) may be scheduled using a single cron application. The cron application acts as a master scheduler and controller for timing when applications and software components should execute to perform the functions of the device monitoring program 120. The cron application also provides for ease and efficiency of horizontal scaling (e.g., adding new features, components, and capabilities to the device monitoring program 120) such that new jobs and new scheduled tasks can be added to the cron application without having to modify other applications executed by the cron application.

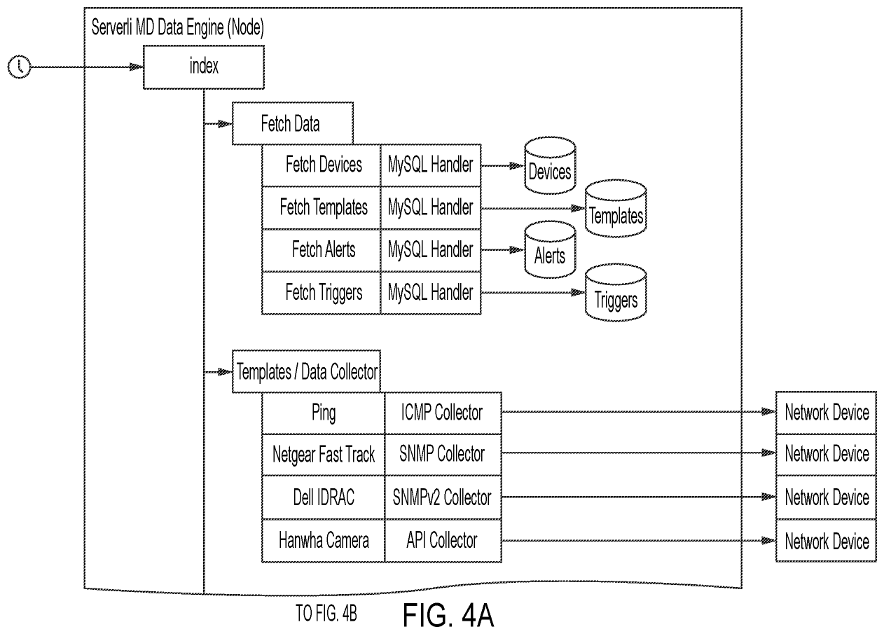

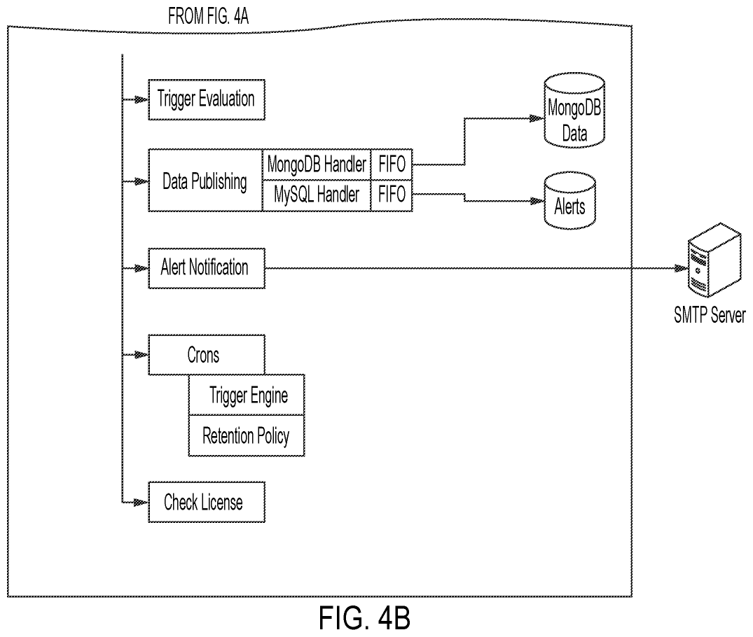

FIG. 4 (FIGS. 4A and 4B) illustrates yet a further exemplary system architecture of the present disclosure in some embodiments. FIG. 4 includes architecture concerning collection and storage of device data (e.g., device monitoring parameters) associated with target devices, such as devices 150a-150n as illustrated in FIG. 1, and generation and publishing of alerts. In the example illustrated in FIG. 4, a monitoring engine 216 (e.g., the Serverli MD Data Engine) verifies the system configurations which includes devices, templates, alerts, and triggers. The monitoring engine 216 performs a system status check on all devices based on the selected communication type (e.g., ICMP, SNMP, SNMPv2, and/or APL). The monitoring engine 216 cross references the captured data with the end user defined triggers and alerts. If a trigger is activated, then an alert will be sent to the end user, for example, via email. Device data and alert data is published and stored in the MongoDB® Database and/or an alerts database.

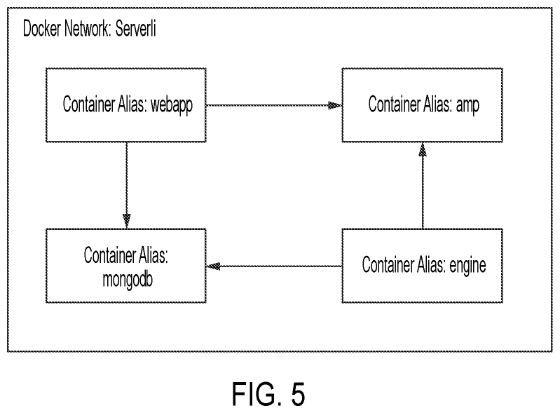

FIG. 5 illustrates further exemplary system architecture of the present disclosure in some embodiments that utilize containers (e.g., Docker® containers) and aliases to implement certain of the functions of the present disclosure. In this way, embodiments may use devices that are agnostic to the implementation details of a software application and/or a service (e.g., device monitoring program 120) such that devices can be added or removed seamlessly and efficiently without requiring excess configuration of the devices and/or software.

As illustrated in FIG. 5, in some embodiments the monitoring system is a containerized application running on the Docker® platform. The webapp, engine, and databases are each executed and/or stored in separate containers which allows for cross platform deployments on all operating systems. As shown by arrows in FIG. 5 connecting each container, data may be transmitted form one container to another. For example, the engine and webapp containers may transmit data to the database containers. Each of the webapp, engine, and database containers are self-contained such that each container may execute separately from the other and may be deployed on a single computing device or multiple computing devices (e.g., distributed computing devices) without requiring configuration of the computing device or specific computing environments (e.g., operating systems).

A container may include a software and/or computing environment that virtualizes an operating system. A container may be deployed (e.g., execute) on a computing device and may be copied and/or moved to multiple other computing devices. The software and/or computing environment of a container may execute on a computing device independent of other software and/or services executing on the same computing device. A container may include all software instructions, including any dependencies or other software libraries, for a single application such that the container may execute on any device and/or operating system without additional configuration. In this way, a container (e.g., a unit of a software program, and application, and/or the like) may be an “out-of-the-box” software application that can be deployed to any device executing any operating system and the container will execute without any additional configuration to the device, the operating system, or the application within the container.

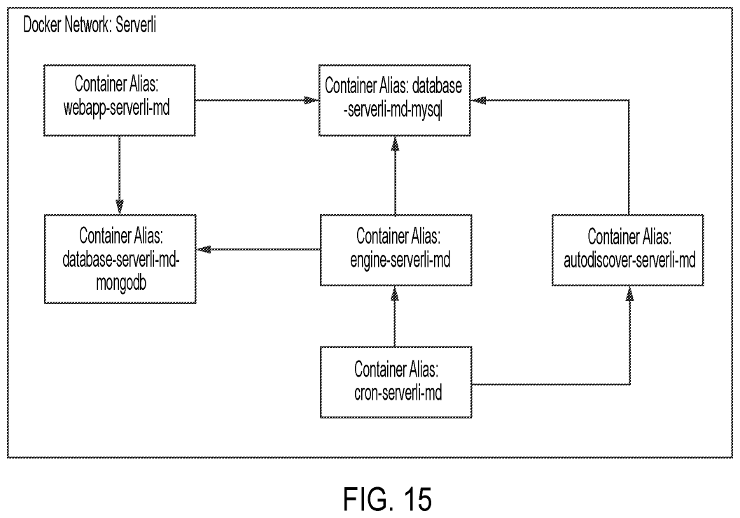

FIG. 15 illustrates a further exemplary system architecture of the present disclosure in some embodiments that may use containers and aliases to implement some of the functions of the present disclosure which further includes a container alias for chronologically scheduled jobs (e.g., cron-serverli-md) and an alias for autodiscovery of various devices (e.g., autodiscover-severli-md).

An alias may include a symbolic name (e.g., “cron-serverli-md”) that may be used by one or more computing devices to access and/or communicate with a data location (e.g., memory, another computing device, and/or the like) where data is stored. The alias may include a symbolic name mapped to an address, such as an IP address, such that a system may only need to have the alias in order to access a device having the IP address associated with and/or mapped to the alias.

The various containers shown in FIG. 15 may be packaged together into a single application that configures multiple containers (e.g., Docker® Compose). A single application that may be used to configure a multi-container environment may be used to manage all containers, view container status, log output of executing containers, and provide a command interface for managing the container environment. Using such a tool may allow for easier deployment of a system of containers (e.g., like the system shown in FIG. 15) such that the system is easier to manage and deploy to various networks.

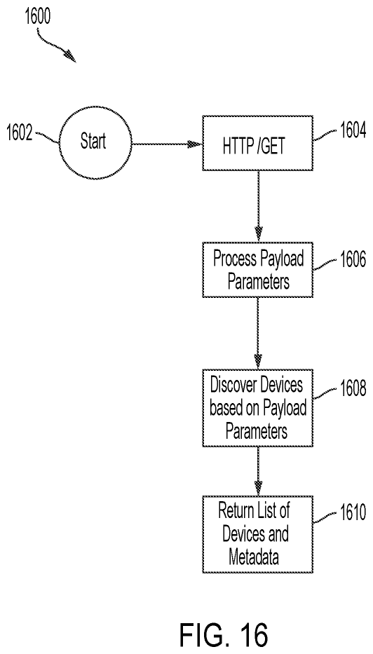

FIG. 16 illustrates a method 1600 for the autodiscovery of devices. An autodiscovery method may allow the device monitoring program 120 to automatically discover devices residing on a network for a user where the devices may not have been predefined in the network or in a device profile of the device monitoring program 120. In some embodiments, an autodiscovery method may be implemented as a separate application through a webapp (e.g., as a tool), or alternatively, may be included as part of the device monitoring program 120 or other component of the device monitoring program 120.

The method 1600 starts with block 1602. At block 1604, processor 104 queries a target device on a network using a suitable querying method, such as a Hypertext Transfer Protocol (HTTP)/GET request. Processor 104 may receive parameters in response to the query and/or request. Example parameters that processor 104 may receive include the number of ports that are open on the device. At block 1606, the parameters received at block 1604 are processed by processor 104. At block 1608, processor 104 may discover a device and information about the device based on the processed parameters (e.g., a discovered device). An example of such a device discovery would be identification of an APACHE webserver or a monitoring camera (e.g., camera 212) of a particular device manufacturer. At block 1610, a list of devices and metadata concerning those devices is returned to an overall calling thread or function of the monitoring system executed by processor 104.

In some embodiments, once processor 104 autodiscovers a target device, processor 104 may make determinations about the target device based on target device data and/or the processed parameters. For example, processor 104 may determine a type of the target device based on what ports are open on the target device. Processor 104 may determine that the target device is a web server if, for example, ports 1, 161, 80, and 443 are open on the device and processor 104 has determined that the ports are open from the query and/or autodiscovery. In this way, an autodiscovery application may make a suggestion to a user about a discovered device such that the user may approve or deny the suggestion by the autodiscovery application. In some embodiments, one or more suggestions may include a list of devices and metadata associated with the devices. The user may also be given an option to add devices to the list of devices. In some embodiments, the autodiscovery application may add a discovered device automatically and autodiscovery of devices may be executed at scheduled times to keep devices up to date (e.g., using a cron).

A person of ordinary skill would appreciate the foregoing autodiscovery method may be implemented by parallel executing threads or could be constructed from a looping structure, among other implementations. In an example embodiment, the device profile module 122 of the device monitoring program 120 may be configured to execute the method of FIG. 16 when the device profile module 122 of the device monitoring program 120 is executed by at least one processor 104.

FIG. 6 illustrates a method 600 for monitoring one or more devices in accordance with exemplary embodiments.

The method 600 may include block 602 of storing, by a processing server (e.g., a processor thereof), a plurality of device profiles for a plurality of devices. Each device profile of the plurality of device profiles may include at least a device type and a device manufacturer. A device of the plurality of devices may include a server, a desktop computing device, a laptop computing device, a mobile device, a hypervisor, a camera, a security sensor, a pressure sensor, a glass break sensor, a motion sensor, a temperature control device, a temperature sensor, a storage array, and/or an Internet-of-Things (IOT) sensor. The plurality of device profiles may be stored in one or more databases such as storage 108.

A device profile may include a set of data associated with a device. In some embodiments, the device profile may represent and/or be associated with a template as described herein. For example, a template may include a data structure to store data for a type of communication protocol associated with a device (and with the device profile of the device). A template may include, for example, an ICMP template that stores the following fields and data:

```
{
  metadata: { // metadata of the template
  name: “ICMP”,
  description: “This is the ICMP template”
  },
  params:{ // params required for engine to do it's job
  ip: “{device.ip_address”,
  port: 1,
  data: 65b,
  ttl: 100
  },
  schema: {
  id: {device.id},
  response: {
  time: {
    value: FLOAT,
    unit: STRING
  },
  timestamp: {
    value: DATETIME
  },
  status: {
    value: INT,
    description: STRING
  }
  }
  }
}
```

Thus, as shown in the example ICMP template, data associated with a device profile may represent and/or be associated with the template because the device profile may include similar device data that is used in an associated template: a device type, a device manufacturer, a device identifier, a device IP address, one or more ports, and/or the like. The data associated with a device profile may be associated with a template, such that when the device profile is selected by a user, a template corresponding to the device profile may be identified by the device monitoring program 120 such that the device monitoring program 120 may communicate with the device associated with the device profile using the data and/or information in the associated template. In this way, a template for a device provides a communication protocol for the device the template is associated with. In this way, the use of templates provides for further compatibility of the device monitoring program with various devices, platforms, operating systems, and/or computing environments.

In an example embodiment, the device profile module 122 of the device monitoring program 120 may be configured to execute on at least one processor to perform the method of block 602.

The method 600 may include block 604 of receiving, by the processing server, a user selection of a device profile of the plurality of device profiles and an IP address for a target device corresponding to the selected device profile. For example, the processing server (e.g., a processor 104 thereof) may receive a network identification from the user identifying the network that includes a device the user wishes to monitor. The user may then select a device profile using an input device connected to the computing device 102 to select an indication on a graphical user interface (e.g., graphical user interface 162) representing a device profile. The processing server may detect an input from the input device corresponding to the user selection of the device profile on the network. In some embodiments, a user may select one or more device profiles of the plurality of device profiles. Once a device profile is selected, the processing server may retrieve an IP address form device data 114 in storage 108 corresponding to the device profile 110 selected by the user.

In this way, the stored data structures for device profiles 110a-110n and device data 114a-114n allow the user to select a device profile for a device without having to know any networking details about the device, such as the IP address, communication ports, communication protocol, and/or other device details. The user can select a device profile to monitor a device simply based on a type and/or manufacturer of a device. Thus, the device monitoring program 120 simplifies device monitoring and security for a user, especially a user who is not a network or information technology professional.

In an example embodiment, the user input module 124 of the device monitoring program 120 may be configured to execute on at least one processor to perform the method of block 604.

The method 600 may include block 606 of receiving, by the processing server, user login credentials associated with the target device, the user login credentials being credentials for a user account used with an application programming interface (API) associated with the manufacturer of the target device. For example, user login credentials may include a username associated with the user and a password associated with the username. User login credentials may be in one of the following formats: SNMP v1, SNMPv2, HTTP, SNMPv3, Secure Shell Protocol (SSH), Windows Management Instrumentation (WMI), Windows, Linux, and/or the like. A user may input the user login credentials for the user account using an input device (e.g., a keyboard) connected to the computing device 102. If the user login credentials are accepted, the user is authorized by the device monitoring program 120 to access the API associated with the manufacturer of the target device. Once the user has access to the API, the API allows the user to enter and submit requests (e.g., requests for data) to the target device and/or a software platform associated with the target device such that the user may receive responses based on requests submitted by the user.

An API may require a specific format of requests and may only allow for certain requests to the target device. In this way, the use of an API with each device for a user to retrieve data associated with the target device reduces complexity for the user because the API provides a limited number of types of requests that can be made along with a defined request format for each request type, such that the user can follow the API format and easily retrieve data associated with the target device. The user does not need any special knowledge and the device monitoring program 120 does not require any special programming by the user to allow the user to retrieve data associated with the target device.

Alternatively, communication with a target device may be accomplished through various other communication protocols. For example, a ping/ICMP response, SNMP request/response, or other communication protocols. In some embodiments, communication with the target device may be based on the template associated with the device and/or device profile.

In an example embodiment, the user input module 124 of the device monitoring program 120 may be configured to execute on at least one processor to perform the method of block 606.

The method 600 may include block 608 of establishing, by the processing server, an active connection through the API (e.g., using the API to establish a communication channel) to the target device and/or to a software platform (e.g., a cloud-based service) associated with the target device. Once the active connection is established through the API, a user may enter API requests using an input device connected to the computing device 102 and the user may submit the requests through the API using the active connection to retrieve data form the target device and/or communicate with the target device. In this way, the use of APIs allows the user to communicate with any device within the network that has a corresponding device profile 110 and/or device data 114 in storage 108 such that complexity is reduced and efficiency of monitoring each device in a network is improved while no additional configuration of the device monitoring program 120 or system is required from the user. In an example embodiment, the device data receipt module 126 of the device monitoring program 120 may be configured to execute on at least one processor to perform the method of block 608.

The method 600 may include block 610 of receiving, by the processing server, one or more device parameter selections from the user, the one or more device parameter selections defining device monitoring parameters. The one or more device parameter selections may include a CPU utilization parameter, a random access memory (RAM) utilization parameter, a hard drive parameter, a network parameter, a bandwidth parameter, a temperature parameter, a device status parameter, a database parameter, or a combination thereof. For example, the processing server may receive a selection from a user of a CPU utilization parameter to define a device monitoring parameter. The device monitoring program 120 would monitor the CPU utilization of a device (e.g., the target device) and may trigger an alert when the CPU utilization surpasses a threshold for the device monitoring parameter. In this way, a user can customize the parameters to be monitored in a network, providing for greater control and security over a network of devices. In some embodiments, the method may include receiving, by the processing server, a device parameter selection update from the user. For example, the processing server may receive an updated device parameter selection following a first device parameter selection from the user, such that the updated device parameter selection is appended to the first device parameter selection from the user or replaces the first device parameter selection from the user. In this way, the user can monitor more than one device parameter for the target device and the device parameters monitored can be changed by the user over time.

In some embodiments, an alert may also be associated with device monitoring parameters relating to hardware failures of devices such as a device being offline, a drive failure, a degraded redundant array of independent disks (RAID), a degraded RAID controller, component failure (e.g., CPU failure, memory failure, power supply failure, network interface controller (NIC) failure, graphics processing unit (GPU) failure, fan failure, and/or the like.

In some embodiments, an alert may also be associated with device monitoring parameters relating to operating system and/or software anomalies such as Windows anomalies, Linux Ubuntu/CentOS/RedHat/Debian/Raspberry Pi anomalies, anomalies in database performance and/or storage space, status of software services, and connectivity of devices.

In some embodiments, an alert may also be associated with device monitoring parameters over time, such as a trend analysis, historical data collection, or historical alert and/or email notifications regarding network devices.

In some embodiments, a user may specify an alert and the processing server may generate new alert data and store the new alert data in an alerts database to be analyzed for an associated device and device monitoring parameter. The user may specify both a device monitoring parameter of the alert and a value of the device monitoring parameter to trigger the alert. In some embodiments, when configuring and/or specifying an alert using a graphical user interface and an input device, a user may be required to configure the alert based on a template type.

In an example embodiment, the user input module 124 of the device monitoring program 120 may be configured to execute on at least one processor to perform the method of block 610.

The method 600 may include block 612 of receiving, by the processing server, target device data via the API. For example, the processing server may receive the target device data in response to transmitting a request to the target device via the API. In an example embodiment, the device data receipt module 126 of the device monitoring program 120 may be configured to execute on at least one processor to perform the method of block 612.

The method 600 may include block 614 of determining, by the processing server, that the device data indicates operation of the target device outside of the one or more device parameter selections. For example, where the device data and the device monitoring parameters include a CPU utilization parameter, device monitoring program 120 (e.g., a processor executing device monitoring program 120) may compare the target device data (e.g., a CPU utilization value of the target device) received from the target device via the API to the device monitoring parameter (e.g., a threshold value of CPU utilization, an operating band of CPU utilization, and/or the like). The device monitoring program 120 may then determine whether the target device data is above or below a threshold value of the device monitoring parameters or outside of an operating band of the device monitoring parameter.

In another example, where the device monitoring parameter is a device status parameter, determining that the device data indicates operation of the target device outside of the one or more device parameter selections may include determining that the target device data indicates that the device status is “error,” “malfunction,” or “offline” where a value of the device monitoring parameter is “operating normally,” “standby,” “online,” and/or the like. In the case of a Boolean parameter, any target device data that indicates “false” where the expected device monitoring parameter is “true” may be considered to be outside of the one or more device parameter selections. In some instances, the user may be able to select and/or specify a value of the device monitoring parameter, such that the user may select whether the device monitoring parameter is set to an expected value of “true,” “false,” or another numeric value in the case of a device monitoring parameter involving a continuous value (e.g., a CPU utilization value).

In an example embodiment, the device data processing module 128 of the device monitoring program 120 may be configured to execute on at least one processor to perform the method of block 614.

The method 600 may include block 616 of generating, by the processing server, an alert indicating the target device is operating outside of the one or more device parameter selections. For example, the processing server may generate the alert based on determining that a target device is operating outside of the one or more device parameter selections. In some embodiments, the alert may include a CPU utilization alert, a RAM utilization alert, a failed create/read/update/delete (CRUD) alert, a failed drive alert, a drive space alert, a dropped packet(s) alert, a device temperature alert, an environmental temperature alert, a device offline/online alert, a motion detection alert, and/or a pressure change alert.

In some embodiments, the alert may be transmitted by the processing server to another device (e.g., a display device 160, a remote computing device, and/or the like) in the form of an email, a short message service (SMS) alert, or a pop-up notification. In some embodiments, the processing server may cause a change in a configuration of the target device in response to the determination that the device data indicates operation of the target device outside of the one or more device parameter selections. For example, in response to determining that the device data indicates operation of the target device outside of the one or more device parameter selections, the processing server may disable a port on the target device, power off the target device, disable all inputs to the target device, shut down a service or software function of the target device, and/or the like. In this way, a user may use the device monitoring program 120 to control one or more devices connected to a network when certain conditions of the devices are detected by the device monitoring program 120 in order to improve security of devices on the network and/or improve the efficiency of device operation within the network.

In an example embodiment, the alert generation module 130 of the device monitoring program 120 may be configured to execute on at least one processor to perform the method of block 616.

The method 600 may include block 618 of transmitting, by the processing server, the alert to a user device. In an example embodiment, the alarm generation module 130 of the device monitoring program 120 may be configured to execute on at least one processor to perform the method of block 618. Block 618 may include other functionality such as changing a configuration on the target device that has generated the alert indicating the target device is operating outside of the one or more device parameter selections. In one embodiment, port 22 (a default port for secure shell (SSH)) may be disabled. As a result, the system may disable the ability for a remote user to access the target device, in reflection of a potential security vulnerability indicated by the operation of the target device outside of the one or more device parameter selections. In this way, some embodiments may offer enhanced security of computing device, computing resources, and other devices part of connected networks.

In some embodiments, the method may include generating, by the processing server, a summary report of one or more alerts for the one or more target devices, wherein the summary report summarizes alerts during a defined period of time. For example, the processing server may generate a summary report that may include a list of one or more alerts, time stamps associated with each alert, a device name, manufacturer, and/or device identifier associated with each alert, and other available information pertaining to each alert. In this way, the device monitoring program 120 and the processing server may provide a snapshot of the status of a network and/or a snapshot of security issues for a defined time period for the network.

In another embodiment, other ports such as port 80, generally used for HTTP services, may be disabled, for example, by the processing server. In yet other embodiments, a specific service or software function of a target device such as its webserver, secure shell (SSH) daemon or any other service may be disabled by the monitoring method performed by the system (e.g., processing server, at least one processor thereof, and/or the like) in reflection of a potential security vulnerability potentially indicated by the operation of the target device outside of the one or more device parameter selections.

In certain embodiments, the foregoing disabling functionality may be expanded to allow a user to scan for the existence of open ports, such as port 22 (the default port for SSH) across all or a subset of devices, and may allow a user to selectively disable such ports across all or a subset of devices where that port is currently open.

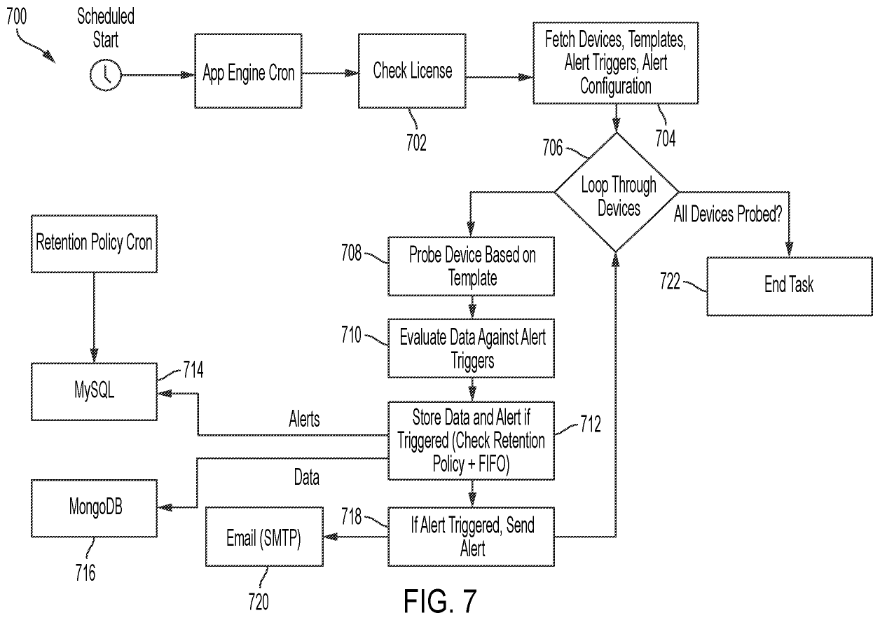

FIG. 7 provides a flowchart of a method 700 for monitoring one or more devices in accordance with example embodiments. The method involves first, by a processing server, executing an app engine cron. The app engine cron may include a daemon (e.g., the cron) executing in a computing device that may be used to schedule certain tasks or software “jobs” on a computing device. The app engine cron executes and schedules the software application (e.g., device monitoring program) to execute at a certain time to perform the process of monitoring one or more devices. The cron can be used to schedule execution of a software application (e.g., device monitoring program 120, monitoring engine 216, etc.) down to a specific minute, hour, day of a month, month, and day of a week. The use of a cron for the app engine (e.g., device monitoring program 120, monitoring engine 216, etc.) allows the execution of the app engine to be scheduled for a specific time, such that device monitoring can be done automatically, at specified times. That is, an application scheduled by a cron can be executed every hour, or at a specific time each day. A cron may be executed in a Unix/Linux environment to execute scheduled tasks and/or jobs.

Once the app engine cron is executing and the application has started executing based on the app engine cron and any scheduled time for execution, processor 104 may check and/or verify a license 702 of the application for performing the monitoring (e.g., device monitoring program 120). The license 702 may reside on a separate license server or may reside on the same computing device that the application is executing on.

The example method then involves a step of fetching, by a processor executing software instructions, devices, templates, alert triggers, and alert configurations 704 from a database. The method then involves looping through the set of target devices 706. The looping 704 involves a repeating step 706 of probing a device based on the retrieved template 708, and evaluating received data against previously set alert triggers 710. The data that is received is stored and an alert is triggered in step 712. Processor 104 may process and store data in step 712 in a first-in-first-out (FIFO) manner in some instances. For example, if disk space reaches ˜90%, processor 104 may process and store data using a FIFO process. In some embodiments, storing data involves a processor storing an alert into a MySQL database 714. In some embodiments, this involves a processor storing received data into a MongoDB® database 716. A retention policy cron may also include a cron to schedule cleanup of data (e.g., daily) in the My SQL database.

If an alert is triggered 718, in an example embodiment an alert email is transmitted to a user at step 720, for example by the alert module 130 discussed throughout this disclosure. The example looping 706 aspect of the embodiment of FIG. 7 completes when all the devices have been probed at step 722. In some embodiments, a “probe all” feature may be utilized through a cron to schedule probing of each device in a network at specific times. Devices that are probed may be successfully probed or devices may fail to be probed. A device that fails to be probed may cause an alert to be generated associated with the device and transmitted to a display device.

In an example implementation of the method of FIG. 7, one of the devices is a switch with template (Internet Control Message Protocol) ICMP and its interface is at the address #. #. #. # on port 1, and probing step 708 of loop 706 involves attempting to connect to the switch via an interface and collect data, which may involve collecting timestamps in the form of the local/server time. In step 710, the received data is evaluated. If in step 710 ICMP returns failure (0), an alert is triggered in step 714 where the alert states that if the response is 0 throw an alert identifier of 1. In some embodiments the sending of an alert is dictated by a configuration that states that if an alert for the trigger that has been tripped has not been tripped in the last X minutes (e.g., 5 minutes), send the alert. In step 712 in that case, the collected data and alert are stored in the MongoDB® database 716 and the MySQL database 714 respectively. An example data structure of the data stored in the MongoDB® database in the presently described example could be as follows:

{
timestamp:
device_id:
data { }
alert: bool
alert_id:
}

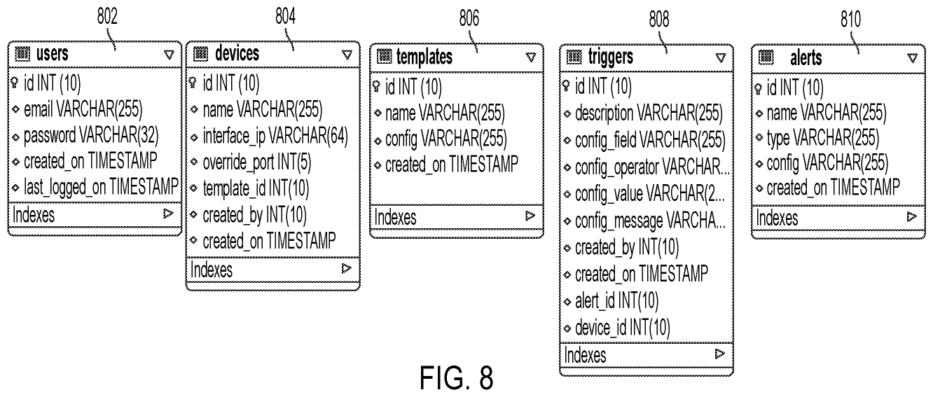

FIG. 8 illustrates various data structures used in example embodiments of the present disclosure in relation to users 802, devices 804, templates for devices 806, triggers 808, and alerts 810. A user data structure 802 may include a user identifier associated with a user, an email address associated with the user, a password, a time stamp for when the user data structure was created, and a time stamp indicating a time and/or date when the user identifier was last detected as “logged in” and/or authenticated to the system (e.g., device monitoring program 120). A device data structure 804 may include a device identifier, a device name, an IP address, a port number, a template identifier, and various other parameters related to the creation of the device data structure. A template data structure 806 may include a template identifier, a template name, a template configuration, and various other parameters related to creation of the template data structure. A trigger data structure 808 may include a trigger identifier, a trigger description, a trigger configuration, and various other parameters related to how the triggered is triggered and its relation to other devices. An alert data structure 810 may include an alert identifier, an alert name, an alert type, an alert configuration, and various parameters related to the creation of the alert data structure.

With the device monitoring program 120, various different data structures 802-810 may be created and instantiated to track different devices, trigger different alerts, and allow for new and/or multiple users and new and/or multiple templates to be added to the system efficiently and easily.

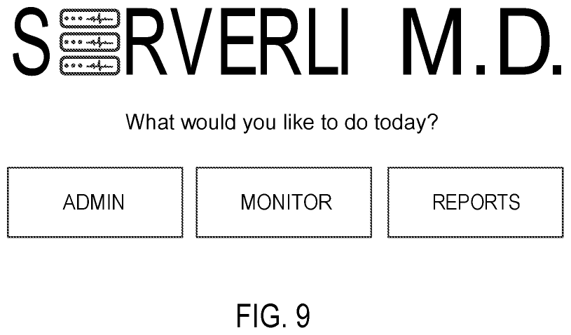

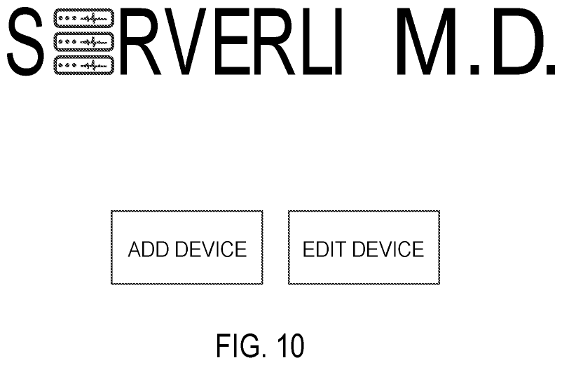

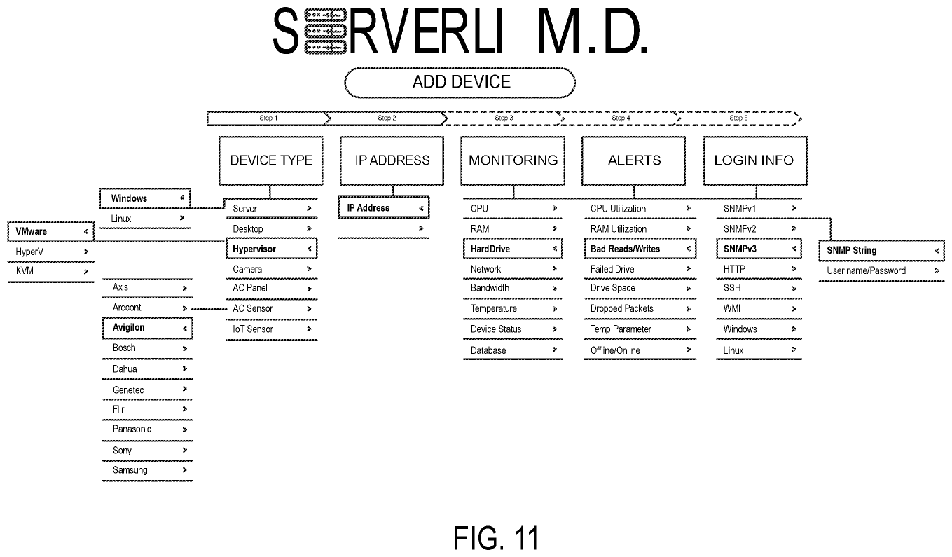

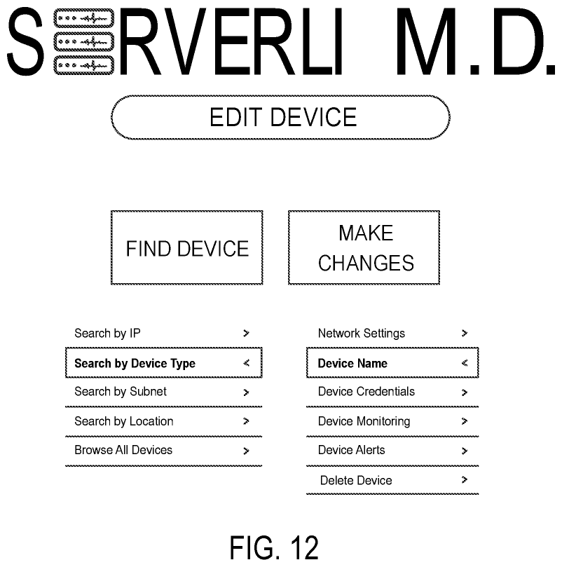

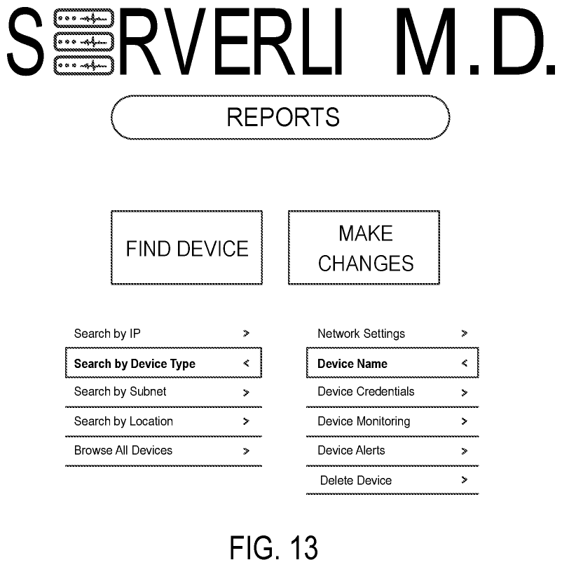

FIGS. 9-13 are block diagrams illustrating graphical user interfaces of the device monitoring program of FIG. 1 in accordance with exemplary embodiments. As an example, FIGS. 10 and 11 show an example work flow to add a device to the system and/or device monitoring program 120. As shown in FIG. 11, the graphical user interface of the example embodiment allows a user to efficiently and easily add a device to include its device type, IP address, the type of monitoring to be performed, alerts to be generated (e.g., bad reads/writes associated with a drive), and login information and credentials associated with the device to be added. Similarly, FIGS. 12 and 13 show interfaces of example embodiments for making changes for a device by first searching (FIG. 12), and the ability to easily generate reports in relation to a device (FIG. 13). With the device monitoring program 120 and system, a device can be added to the system as a new device without any configuration of the device monitoring program 120 or system itself, due to the use of containers and other configuration-agnostic components. Thus, a device can be added efficiently and without any special configuration, knowledge, or troubleshooting.

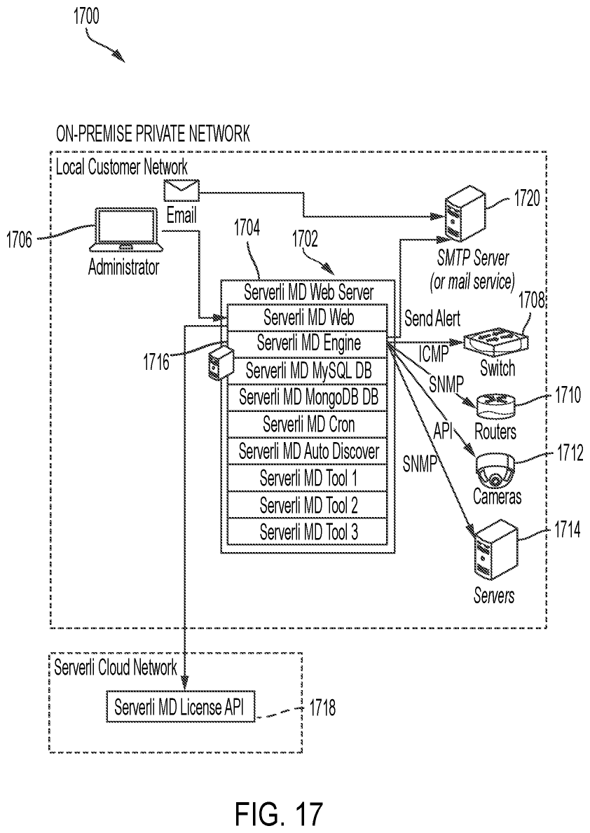

FIG. 17 shows a block diagram of the device monitoring program 120 implemented in a private on-premise network 1700. As shown in FIG. 17, some embodiments of the present disclosure may support and monitor devices for a private on-premise network. For example, the software application (e.g., device monitoring program) 1702 may include at least an engine 1716 and various other software components (e.g., databases, tools, autodiscovery, etc.) as embodiments described herein. The software application 1702 may be deployed on a private server such as a web server 1704, with the private server located at a specific location (e.g., on-premise), and the software application may perform device monitoring for devices on a private, local network associated with the private server on which the device monitoring program 1702 is executing. That is, the device monitoring program 1702 may execute on the same local network in which the monitored devices are located and connected to. The private, local network may include devices such as switch 1708, router 1710, camera 1712, and/or server 1714 that may be monitored by device monitoring program 1702. The on-premise private network may include at least one administrator 1706 (e.g., a user) to control the device monitoring program 1702. Additionally, the on-premise private network may include a SMTP server 1720 to receive alerts from the device monitoring program 1702 and to transmit email notifications to a user (e.g., administrator 1706). The software application 1702 may communicate with a license API 1718 to a license server executing on a cloud network or other computing device to validate a license of the on-premise private network and/or administrator 1706.

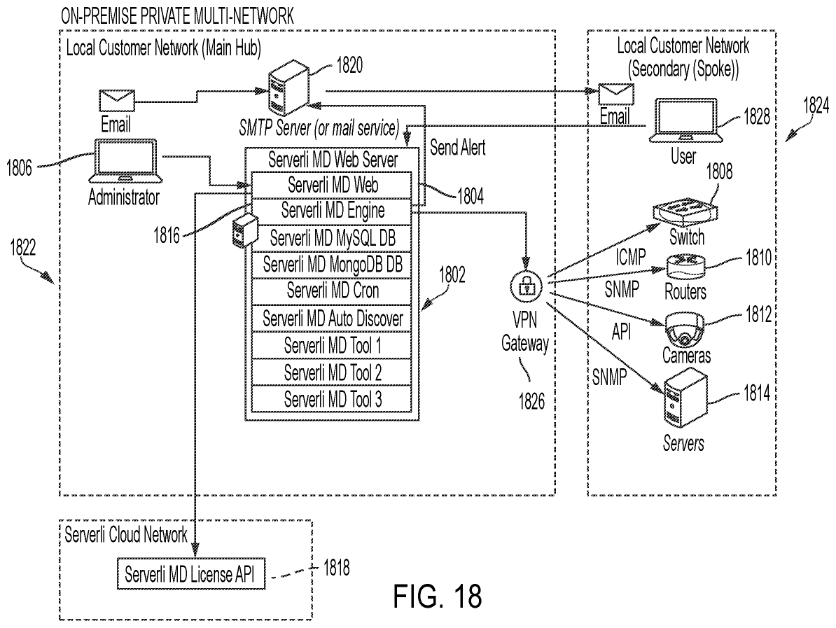

As shown in FIG. 18, some embodiments of the present disclosure may support private on-premise multi-networks. A software application (e.g., a device monitoring program) may include an engine 1816 and various other software components (e.g., databases, tools, autodiscovery, etc.) and may execute in a multi-network environment. For example, the software application (e.g., device monitoring program) 1802 may be deployed on a web server 1804 connected to a main hub network 1822 at a specific location (e.g., on-premise). The software application 1802 may perform device monitoring for devices on separate secondary networks 1824 that are connected to the main hub network 1822 and associated with the main hub network 1822. The device monitoring program 1802 may execute on a main hub network 1822 and the device monitoring program 1802 may communicate with one or more secondary networks 1824 via a virtual private network (VPN) gateway 1826, such that devices (e.g., switch 1808, routers 1810, cameras 1812, servers 1814, etc.) connected to the secondary networks 1824 may be monitored. In this way, a user and/or user device 1828 connected to a secondary network 1824 may connect to the device monitoring program 1802 to leverage the device monitoring capabilities of the main hub network 1822 to monitor devices on any of the secondary networks 1824 connected to the main hub network via a VPN gateway 1826. The software application 1802 may communicate with a license API 1818 executing on a license server on a cloud network or other computing device to validate a license of the on-premise main hub network 1822 and/or administrator 1806.

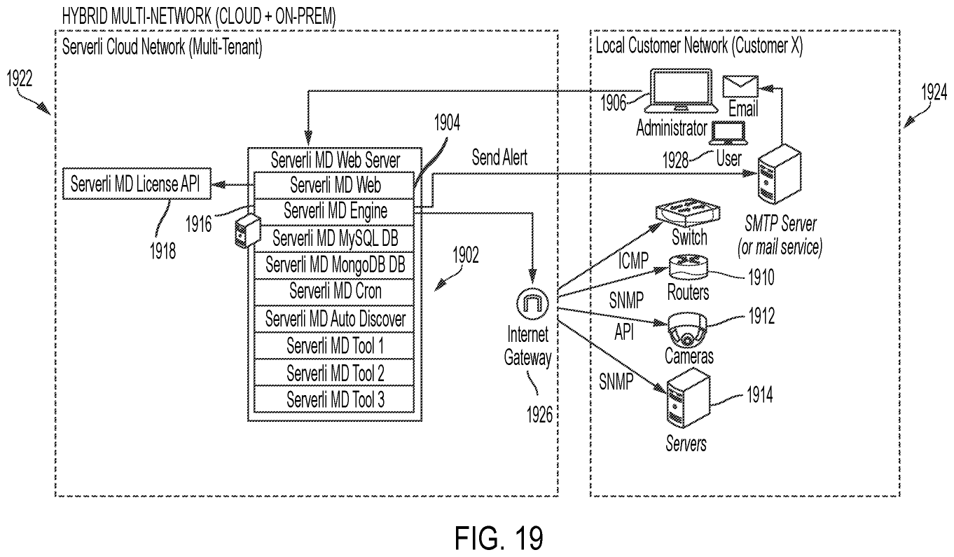

As shown in FIG. 19, some embodiments of the present disclosure may support a cloud-hybrid network 1922. A software application (e.g., a device monitoring program) may include an engine 1916 and various other software components (e.g., databases, tools, autodiscovery, etc.) and may execute in a cloud environment. For example, the software application 1902 may execute in the cloud at a central server as software as a service (SaaS) executing as a web server 1904 where the software application is centralized along with a license API 1918 executing on a license server at the central location. The device monitoring program 1902 may execute at a central server and the device monitoring program 1902 may connect to outside networks 1924 (e.g., customer networks, and/or the like) to monitor devices on the outside networks 1924 from the central server via an Internet gateway 1926 (e.g., over the Internet). In this way, a user and/or user device 1928 connected to an outside network 1928 (e.g., the user's own private network) may connect to the device monitoring program 1902 over the Internet and executing in the cloud at a central server to leverage the device monitoring capabilities of the device monitoring program 1902 from any location and almost any network 1922 to monitor devices (e.g., switch 1908, routers 1910, cameras 1912, and servers 1914) on the user's network 1924 via the Internet gateway 1926. Such access to device monitoring provides for simple and improved security of networks and systems without deployment and maintenance of separate applications executing on multiple networks, but instead use of a single application executing at a central location. The software application 1902 may communicate with a license API 1918 executing on a license server on a cloud network or other computing device to validate a license of a network 1924 and/or administrator 1906 and customer 1928.

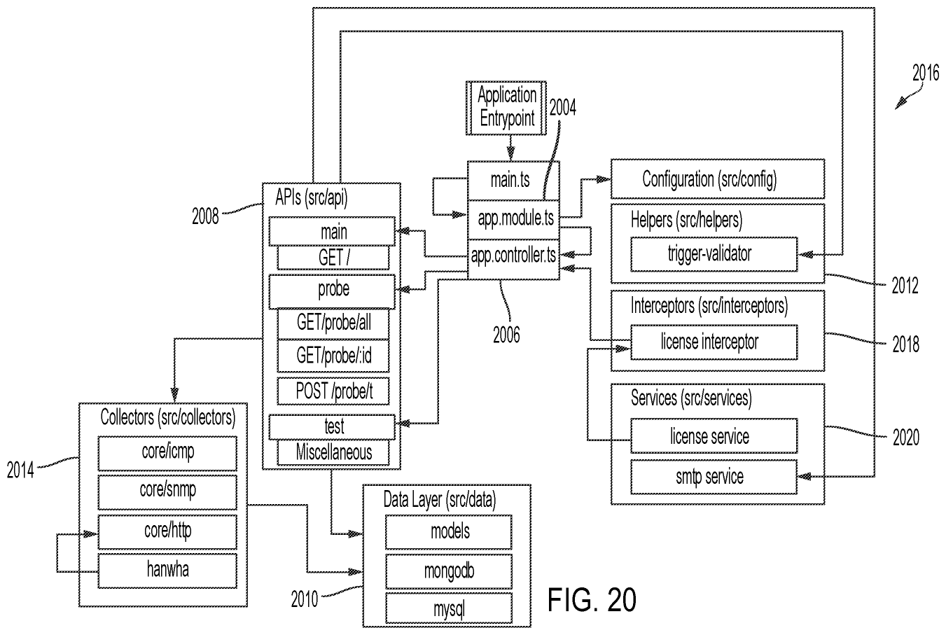

FIG. 20 is a schematic diagram of an application engine 2016 (e.g., the same as or similar to monitoring engine 216, engine 1716, engine 1816, engine 1916, etc.) for the device monitoring program 120 (e.g., the same as or similar to device monitoring program 1702, 1802, 1902, etc.). The application engine 2016 may include software instructions for a data application 2004 and software instructions for a controller 2006. The engine may include at least one API 2008 to perform HTTP requests, such as GET/and POST/. At least one API 2008 may be used for probing one or more devices in a network. For example, the engine 2016 may use an API 2008 to probe all devices in a network, probe a device based on a device identifier, or probe devices based on a template type (e.g., collectors 2014). The engine 2016 may include a data layer 2010 for accessing data models and various databases associated with the engine 2016. The engine 2016 may use a helper (e.g., trigger-validator) 2012 to determine if an alert needs to be transmitted to a user or not. The engine 2016 may also include an interceptor 2018 (e.g., a software design pattern used to augment a normal processing cycle, used to perform a validation task) to perform a task to validate licenses. In this way, an interceptor design allows the engine 2016 to avoid checking for and/or validating a license for every single component within the application and allows for validation of licenses at specific times rather than having to check for and/or validate a license in each cycle of the device monitoring program 120. The engine 2016 may include various services 2020 to handle transmitting alerts and validating licenses.

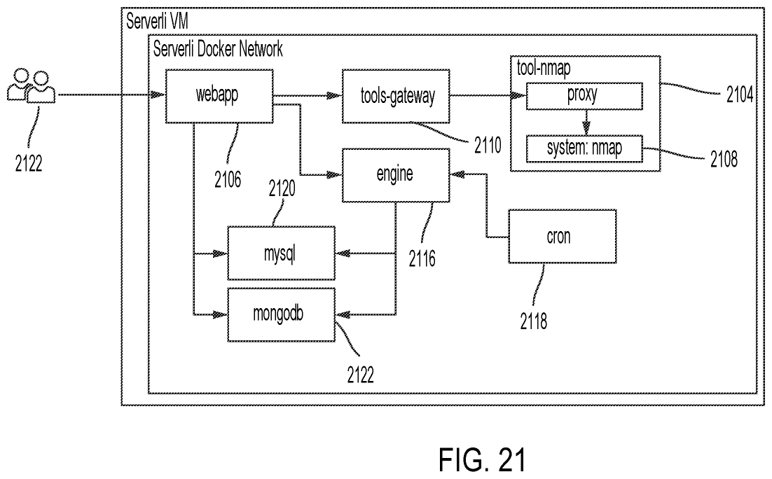

FIG. 21 shows an exemplary implementation of a device monitoring program in the form of a web application. As shown in FIG. 21, the device monitoring program 120 (e.g., the same as or similar to device monitoring program 1702, 1802, 1902, etc.) may include one or more tools 2104 to perform certain functions on a network such as network scanning, port scanning, and/or the like. The device monitoring program 120 may further include an engine 2116 as described herein, a cron 2118 as described herein, a MySQL database 2120 as described herein, and/or a MongoDB database 2122 as described herein.

A tool 2104 may perform a function on a remote network where the tool executes at a centralized location and/or server and operates on the remote network over a network boundary (e.g., over the Internet, over a wide area connection, other types of networks, etc.). In some embodiments, each tool 2104 of the one or more tools 2104 may perform a specific function, and each tool 2104 may be accessible through a web application (e.g., “webapp”) 2106 and/or a web server executing and hosting the device monitoring program 120.

As shown in FIG. 21, the one or more tools 2104 may include a network scanner such as a nmap tool 2108. The nmap tool 2108 may be configured to perform network scanning, network discovery, and/or security auditing to augment capabilities of the device monitoring program 120. The nmap tool 2108 may provide a layer of network monitoring on top of the capabilities of the device monitoring program 120 to provide additional information about devices and the network to a user 2124. The system and device monitoring program 120 may have new tools 2104 added that may be accessible to a user 2124 through a tools-gateway 2110 that may provide communication from the webapp 2106 to the tools 2104 in conjunction with the device monitoring program 120. In some embodiments, the engine (e.g., monitoring engine 216) may be provided as a tool 2104 such that the architecture of the webapp 2106 and tools 2104 is more easily scalable without requiring additional resources to scale the functionalities and add new features to each tool 2104.

In some embodiments, the one or more tools 2104 may be a part of the device monitoring program 120. Alternatively, the one or more tools 2104 may execute separately from the device monitoring program 120 on separate computing devices (e.g., distributed computing devices). The one or more tools 2104 may execute in conjunction with the device monitoring program 120 such that each tool 2104 of the one or more tools 2104 may have access to components (e.g., databases) of the device monitoring program 120. In this way, the use of one or more tools may enhance the functionality of the device monitoring program 120 and associated methods without requiring changes or rework to the device monitoring program 120 itself, thus reducing resources required for development and testing of the device monitoring program 120 when new features are added or existing features are updated.

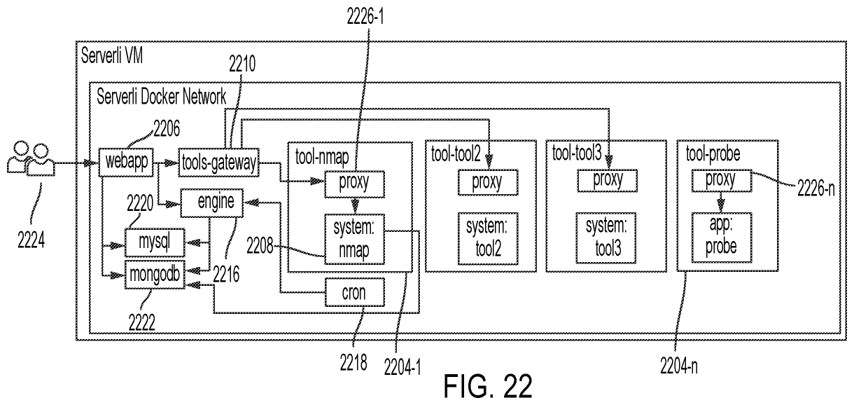

FIG. 22 shows another embodiment of a device monitoring program architecture accessible through a web application (e.g., “webapp,” accessible through a web browser over the Internet). The device monitoring program 120 architecture shown in FIG. 22 may be the same as or similar to the device monitoring program 120 architecture shown in FIG. 21. A webapp 2206 may be used to provide access to the functionality of the device monitoring program 120 to users 2224 while remaining platform agnostic. That is, the webapp 2206 may be accessible by a user 2224 from any device that can run a web browser and has a connection to the Internet. The type of device, or operating system executing on the device does not have an effect on the user's 2224 ability to access the webapp 2206. In this way, the device monitoring program 120 may be offered to and used on many platforms without requiring additional rework or testing in order to execute on specific platforms.

From the webapp 2206 in FIG. 22, a user 2224 may have access to a tool 2204-1 to 2204-n in a set of tools 2204 (referred to individually as 2204-n and collectively as 2204, where appropriate) (e.g., tool-nmap 2204-1). A user 2224 accessing the device monitoring program 120 through the webapp 2206 may execute a tool 2204 on a network and an engine 2216 may still be configured to perform device monitoring functions as described herein to generate alerts for specific devices using device parameters selected by the user 2224. Thus, the use of tools 2204 and the webapp 2206 provide additional functionality for the user 2224 to access the device monitoring program 120 without requiring complicated downloads or configuration. The device monitoring program 120 may reside and execute in a central location such that any changes or updates that are required and completed are immediately accessible to all users 2224 of the device monitoring program 120, without requiring complicated deployment or testing of updates or new features.

FIG. 22 shows an exemplary implementation of a device monitoring program in the form of a web application having multiple tools 2204. As shown in FIG. 22, each tool 2204 may include a proxy 2226 (referred to individually as proxy 2226-n and collectively as proxies 2226, where appropriate) such that a user 2224 may leverage the functions of each tool 2204 securely. A proxy 2226 for a tool 2204 may provide for separation between a system-level application that performs the function of the tool 2204 on a network and the webapp 2206/user device 2224 that initiated the use of the tool 2204.

A person having ordinary skill in the art would appreciate that embodiments of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. For instance, one or more of the disclosed modules may be a hardware processor device with an associated memory.

A hardware processor device as discussed herein may be a single hardware processor, a plurality of hardware processors, or combinations thereof. Hardware processor devices may have one or more processor “cores.” The term “non-transitory computer readable medium” as discussed herein is used to generally refer to tangible media such as a memory device.

Various embodiments of the present disclosure are described in terms of an example computing device. It will be apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single and/or multi-processor machines. In addition, in some embodiments the order of operations may be rearranged without departing from the spirit of the disclosed subject matter.

A system, as used herein, may be in combination with one or more nodes, wherein the system resides in the one or more nodes. A node may be configured to interface and/or contain one or more components of the systems described herein. A node may include a point on a network containing one/or more devices that may transmit, receive, store, and/or generate data. For example, a single server within a network may be classified as one node. Additionally or alternatively, a data center or large group of multiple servers may be classified as a single node in a network.

A hardware processor, as used herein, may be a special purpose or general purpose processor device. The hardware processor device may be connected to a communications infrastructure, such as a bus, message queue, network, multi-core message-passing scheme, etc. An example computing device, as used herein, may include a memory (e.g., random access memory, read-only memory, etc.), and may also include one or more additional memories. The memory and the one or more additional memories may be read from and/or written to in a well-known manner. In some embodiments, the memory and/or the one or more additional memories may be non-transitory computer readable recording media.

Data stored in the example computing device (e.g., in the memory or another storage device) may be stored on any type of suitable computer readable media, such as optical storage (e.g., a compact disc, digital versatile disc, Blu-ray disc, etc.), magnetic tape storage (e.g., a hard disk drive), solid-state drive, etc. An operating system may be stored in the memory.

In an exemplary embodiment, the data may be configured in any type of suitable data storage configuration or database configuration, such as a relational database, a structured query language (SQL) database, a distributed database, an object database, etc. Suitable configurations and storage types will be apparent to persons having skill in the relevant art.

The example computing device may also include a communications interface. The communications interface may be configured to allow software and data to be transmitted between the computing device and external devices. Example communications interfaces may include a modem, a network interface (e.g., an Ethernet card), a communications port, a PCMCIA slot and card, etc. Software and data transferred via the communications interface may be in the form of signals, which may be electronic, electromagnetic, optical, or other signals as will be apparent to persons having skill in the relevant art. The signals may travel via a communications path, which may be configured to carry the signals and may be implemented using wire, cable, fiber optics, a phone line, a cellular phone link, a radio frequency link, etc.

Memory semiconductors (e.g., DRAMs, etc.) may be means for providing software to the computing device. Computer programs (e.g., computer control logic and/or instructions) may be stored in the memory. Computer programs may also be received via the communications interface. Such computer programs, when executed by a processor, may enable the computing device to implement the present methods as discussed herein. In particular, the computer programs stored on a non-transitory computer-readable medium, when executed by a processor, may enable a hardware processor device to implement the example methods, or similar methods, as discussed herein. Accordingly, such computer programs may represent controllers of the computing device.

Where the present disclosure is implemented using software, the software may be stored in a computer product or non-transitory computer readable medium and loaded into the computing device using a removable storage drive or communications interface. In an example embodiment, any computing device disclosed herein may also include a display interface that outputs display signals to a display unit, e.g., LCD screen, plasma screen, LED screen, DLP screen, CRT screen, etc.

### Computer System Architecture

FIG. 14 illustrates a computer system 1400 in which embodiments of the present disclosure, or portions thereof, may be implemented as computer-readable code. For example, the computing device 102, and the display device 160 of FIG. 1 may be implemented in the computer system 1400 using hardware, non-transitory computer readable media having instructions stored thereon, or a combination thereof and may be implemented in one or more computer systems or other processing systems. Hardware may embody modules and components used to implement the methods of FIGS. 6 and 7.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described example embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 1418, a removable storage unit 1422, and a hard disk installed in hard disk drive 1412.

Various embodiments of the present disclosure are described in terms of this example computer system 1400. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 1404 may be a special purpose or a general purpose processor device specifically configured to perform the functions discussed herein. The processor device 1404 may be connected to a communications infrastructure 1406, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 1400 may also include a main memory 1408 (e.g., random access memory, read-only memory, etc.), and may also include a secondary memory 1410. The secondary memory 1410 may include the hard disk drive 1412 and a removable storage drive 1414, such as a floppy disk drive, a magnetic tape drive, an optical disk drive, a flash memory, etc.

The removable storage drive 1414 may read from and/or write to the removable storage unit 1418 in a well-known manner. The removable storage unit 1418 may include a removable storage media that may be read by and written to by the removable storage drive 1414. For example, if the removable storage drive 1414 is a floppy disk drive or universal serial bus port, the removable storage unit 1418 may be a floppy disk or portable flash drive, respectively. In one embodiment, the removable storage unit 1418 may be non-transitory computer readable recording media.

In example embodiments, the secondary memory 1410 may include alternative means for allowing computer programs or other instructions to be loaded into the computer system 1400, for example, the removable storage unit 1422 and an interface 1420. Examples of such means may include a program cartridge and cartridge interface (e.g., as found in video game systems), a removable memory chip (e.g., EEPROM, PROM, etc.) and associated socket, and other removable storage units 1422 and interfaces 1420 as will be apparent to persons having skill in the relevant art.

Data stored in the computer system 1400 (e.g., in the main memory 1408 and/or the secondary memory 1410) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 1400 may also include a communications interface 1424. The communications interface 1424 may be configured to allow software and data to be transferred between the computer system 1400 and external devices. Example communications interfaces 1424 may include a modem, a network interface (e.g., an Ethernet card), a communications port, a PCMCIA slot and card, etc. Software and data transferred via the communications interface 1424 may be in the form of signals, which may be electronic, electromagnetic, optical, or other signals as will be apparent to persons having skill in the relevant art. The signals may travel via a communications path 1426, which may be configured to carry the signals and may be implemented using wire, cable, fiber optics, a phone line, a cellular phone link, a radio frequency link, etc.

The computer system 1400 may further include a display interface 1402. The display interface 1402 may be configured to allow data to be transferred between the computer system 1400 and external display 143. Example display interfaces 1402 may include high-definition multimedia interface (HDMI), digital visual interface (DVI), video graphics array (VGA), etc. The display 143 may be any suitable type of display for displaying data transmitted via the display interface 1402 of the computer system 1400, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 1408 and secondary memory 1410, which may be memory semiconductors (e.g., DRAMs, etc.). These computer program products may be means for providing software to the computer system 1400. Computer programs (e.g., computer control logic) may be stored in the main memory 1408 and/or the secondary memory 1410. Computer programs may also be received via the communications interface 1424. Such computer programs, when executed, may enable computer system 1400 to implement the present methods as discussed herein. In particular, the computer programs, when executed by processor device 1404, may enable processor device 1404 to implement the methods illustrated by FIGS. 6 and 7, as discussed herein. Accordingly, such computer programs may represent controllers of the computer system 1400. Where the present disclosure is implemented using software, the software may be stored in a computer program product and loaded into the computer system 1400 using the removable storage drive 1414, interface 1420, and hard disk drive 1412, or communications interface 1424.

The processor device 1404 may comprise one or more modules or engines configured to perform the functions of the computer system 1400. Each of the modules or engines may be implemented using hardware and, in some instances, may also utilize software, such as corresponding to program code and/or programs stored in the main memory 1408 or secondary memory 1410. In such instances, program code may be compiled by the processor device 1404 (e.g., by a compiling module or engine) prior to execution by the hardware of the computer system 1400. For example, the program code may be source code written in a programming language that is translated into a lower level language, such as assembly language or machine code, for execution by the processor device 1404 and/or any additional hardware components of the computer system 1400. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 1400 to perform the functions disclosed herein. It will be apparent to persons having skill in the relevant art that such processes result in the computer system 1400 being a specially configured computer system 1400 uniquely programmed or configured to perform the functions discussed above.

It will be appreciated by those skilled in the art that the present disclosure may be embodied in other specific forms without departing from the spirit or essential characteristics thereof. The presently disclosed embodiments are therefore considered in all respects to be illustrative and not restrictive. The scope of the disclosure is indicated by the appended claims rather than the foregoing description, and all changes that come within the meaning, range, and equivalence thereof are intended to be embraced therein.

What is claimed is:

1. A method for monitoring one or more devices, the method comprising:
storing, by a processing server, a plurality of device profiles for a plurality of devices, each device profile of the plurality of device profiles including at least a device type and a device manufacturer;
receiving, by the processing server, a user selection of a device profile of the plurality of device profiles and an internet protocol (IP) address for a target device corresponding to the selected device profile;
receiving, by the processing server, user login credentials associated with the target device, the user login credentials being credentials for a user account used with an application programming interface (API) associated with the manufacturer of the target device;
establishing, by the processing server, an active connection through the API to the target device and/or to a software platform associated with the target device;
receiving, by the processing server, one or more device parameter selections from the user, the one or more device parameter selections defining device monitoring parameters;
receiving, by the processing server, target device data via the API;
determining, by the processing server, that the device data indicates operation of the target device outside of the one or more device parameter selections;
generating, by the processing server, an alert indicating the target device is operating outside of the one or more device parameter selections; and
transmitting, by the processing server, the alert to a user device.

2. The method of claim 1, wherein receiving an IP address for a device corresponding to the selected device profile includes:
receiving, by the processing server, a network identification from the user; and
detecting, by the processing server, a user device corresponding to the selected device profile on the network.

3. The method of claim 1, wherein the plurality of devices includes one or more from the group consisting of: a server, a desktop computing device, a laptop computing device, a mobile device, a hypervisor, a camera, a security sensor, a pressure sensor, a glass break sensor, a motion sensor, a temperature control device, a temperature sensor, and an Internet-of-Things (IOT) sensor.

4. The method of claim 1, wherein the user login credentials are in the format of one of the following: Simple Network Management Protocol (SNMP) v1, SNMPv2, Hypertext Transfer Protocol (HTTP), SNMPv3, Secure Shell Protocol (SSH), Windows Management Instrumentation (WMI), Windows, Linux.

5. The method of claim 1, wherein the one or more device parameter selections include one or more of: a computer processing unit (CPU) utilization parameter, a random access memory (RAM) utilization parameter, a hard drive parameter, a network parameter, a bandwidth parameter, a temperature parameter, a device status parameter, and a database parameter.

6. The method of claim 1, wherein the alert is one or more of: a CPU utilization alert, a RAM utilization alert, a failed create/read/update/delete (CRUD) alert, a failed drive alert, a drive space alert, a dropped packet(s) alert, a device temperature alert, an environmental temperature alert, a device offline/online alert, a motion detection alert, and a pressure change alert.

7. The method of claim 1, wherein the alert is one or more of: an email, a short message service (SMS) alert, and a pop-up notification.

8. The method of claim 1, including:
generating, by the processing server, a summary report of one or more alerts for the one or more target devices, wherein the summary report summarizes alerts during a defined period of time.

9. The method of claim 1, including:
receiving, by the processing server, a device parameter selection update from the user.

10. A system for monitoring one or more devices, the system comprising: a processing device configured to:
store a plurality of device profiles for a plurality of devices, each device profile of the plurality of device profiles including at least a device type and a device manufacturer;
receive a user selection of a device profile of the plurality of device profiles and an IP address for a target device corresponding to the selected device profile;
receive user login credentials associated with the target device, the user login credentials being credentials for a user account used with an application programming interface (API) associated with the manufacturer of the target device;
establish an active connection through the API to the target device and/or to a software platform associated with the target device;
receive one or more device parameter selections from the user, the one or more device parameter selections defining device monitoring parameters;
receive target device data via the API;
determine that the device data indicates operation of the target device outside of the one or more device parameter selections;
generate an alert indicating the target device is operating outside of the one or more device parameter selections; and
transmit the alert to a user device.

11. The system of claim 10, wherein receiving an IP address for a device corresponding to the selected device profile includes:
the processing device configured to:
receive a network identification from the user; and
detect a user device corresponding to the selected device profile on the network.

12. The system of claim 10, wherein the plurality of devices includes one or more from the group consisting of: a server, a desktop computing device, a laptop computing device, a mobile device, a hypervisor, a camera, a security sensor, a pressure sensor, a glass break sensor, a motion sensor, a temperature control device, a temperature sensor, and an Internet-of-Things (IOT) sensor.

13. The system of claim 10, wherein the user login information is in the format of one of the following: Simple Network Management Protocol (SNMP) v1, SNMPv2, Hypertext Transfer Protocol (HTTP), SNMPv3, Secure Shell Protocol (SSH), Windows Management Instrumentation (WMI), Windows, Linux.

14. The system of claim 10, wherein the one or more parameter selections include one or more of: a computer processing unit (CPU) utilization parameter, a random access memory (RAM) utilization parameter, a hard drive parameter, a network parameter, a bandwidth parameter, a temperature parameter, a device status parameter, and a database parameter.

15. The system of claim 10, wherein the alert is one or more of: a CPU utilization alert, a RAM utilization alert, a failed create/read/update/delete (CRUD) alert, a failed drive alert, a drive space alert, a dropped packet(s) alert, a device temperature alert, an environmental temperature alert, a device offline/online alert, a motion detection alert, and a pressure change alert.

16. The system of claim 10, wherein the alert is one or more of: an email, a short message service (SMS) alert, and a pop-up notification.

17. The system of claim 10, including:
the processing device configured to:
generate a summary report of one or more alerts for the one or more target devices, wherein the summary report summarizes alerts during a defined period of time.

18. The system of claim 10, including:
the processing device configured to:
receive a device parameter selection update from the user.

19. A computer program product for monitoring one or more devices, the computer program product comprising:
a computer-readable storage medium having program instructions embodied therewith, the program instructions executable by a computer to cause the computer to perform a method, including:
storing, by a processing server, a plurality of device profiles for a plurality of devices, each device profile of the plurality of device profiles including at least a device type and a device manufacturer;
receiving, by the processing server, a user selection of a device profile of the plurality of device profiles and an IP address for a target device corresponding to the selected device profile;
receiving, by the processing server, user login credentials associated with the target device, the user login credentials being credentials for a user account used with an application programming interface (API) associated with the manufacturer of the target device;
establishing, by the processing server, an active connection through the API to the target device and/or to a software platform associated with the target device;
receiving, by the processing server, one or more device parameter selections from the user, the one or more device parameter selections defining device monitoring parameters;
receiving, by the processing server, target device data via the API;
determining, by the processing server, that the device data indicates operation of the target device outside of the one or more device parameter selections;
generating, by the processing server, an alert indicating the target device is operating outside of the one or more device parameter selections; and
transmitting, by the processing server, the alert to a user device.

20. The computer program product of claim 19, wherein the alert is one or more of: an email, a short message service (SMS) alert, and a pop-up notification.
